(19) United States
(12) Patent Application Publication
(10) Pub. No.: US 2022/0325122 A1
(43) Pub. Date: Oct. 13, 2022

(54) Ink Set And Recording Method

(71) Applicant: Seiko Epson Corporation, Tokyo (JP)

(72) Inventors: Yuta ASAKAWA, Azumino (JP); Mitsuaki KOSAKA, Minowa (JP)

(21) Appl. No.: 17/706,699

(22) Filed: Mar. 29, 2022

(30) Foreign Application Priority Data
Mar. 30, 2021 (JP) 2021-057422

(51) Int. Cl. C09D 11/54; C09D 11/033; C09D 11/037; C09D 11/38; B41M 5/00; B41M 7/00

(52) U.S. Cl. CPC C09D 11/54; C09D 11/033; C09D 11/037; C09D 11/38; B41M 5/0011; B41M 5/0023; B41M 5/0064; B41M 7/009

(57) ABSTRACT

A form of an ink set is an ink set including a flocculant-containing treatment liquid and an ink jet ink composition and is for use in recording on a low- or non-absorbent recording medium. The ink jet ink composition is a water-based ink containing at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C. The organic compound sparingly soluble in water includes a diol or glycol ether having a normal boiling point of 180° C. to 300° C., with the diol or glycol ether constituting 2.3% by mass or less of the total mass of the ink composition.

The present application is based on, and claims priority from JP Application Serial Number 2021-057422, filed Mar. 30, 2021, the disclosure of which is hereby incorporated by reference herein in its entirety.

### BACKGROUND

### 1. Technical Field

The present disclosure relates to an ink set and a recording method.

### 2. Related Art

Ink jet recording, a known technology in which an image is recorded on a recording medium by ejecting tiny ink droplets from nozzles of a recording head of an ink jet recording apparatus, is under study for use in the fields of sign printing and high-speed label printing. A class of ink that is studied is the water-based ink jet ink composition, an ink composition that contains water as one of its primary solvents (hereinafter also referred to as “water-based ink” or “ink”). For reasons such as their friendliness to the global environment and safety to the human body, inks in this category are investigated for their potential use in image recording on a recording medium that absorbs little ink (e.g., art paper or coated paper) or no ink (e.g., plastic films).

A known technique in such recording with water-based ink(s) on a low- or non-absorbent recording medium is to use a treatment liquid that makes ingredients in the ink(s) flocculate together. This is done to improve the quality of the image, i.e., to fix the ink(s) attached to the recording medium earlier and thereby reduce the gathering of ink dots (ink bleed) (e.g., see JP-A-2018-154014).

On a low- or non-absorbent recording medium, however, water-based inks do not spread smoothly (do not fill space on the recording medium well). Hence this type of recording often suffers the defect called banding irregularities, band-shaped irregularities on the recorded image caused by slight variations in the quantity of ink droplets ejected from the nozzles or minor misalignment of the landing position of the ink droplets.

The type of recording using a treatment liquid that makes ingredients in inks flocculate together, performed to improve the quality of the image, more often suffers banding irregularities because the flocculation further prevents the ink droplets from spreading on the recording medium. Without a treatment liquid, however, the image quality is poor because ink bleed is not reduced.

The use of a treatment liquid also has other disadvantages. The storage stability of the ink(s) tends to be low because of contaminants that form during drying, and the resulting record is inferior in abrasion resistance.

### SUMMARY

A form of an ink set according to an aspect of the present disclosure is an ink set including a flocculant-containing treatment liquid; and an ink jet ink composition, the ink set being for use in recording on a low- or non-absorbent recording medium, wherein the ink jet ink composition is a water-based ink containing at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C.; and the organic compound sparingly soluble in water includes a diol or glycol ether having a normal boiling point of 180° C. to 300° C., with the diol or glycol constituting 2.3% by mass or less of a total mass of the ink composition.

A form of a recording method according to an aspect of the present disclosure is a recording method in which recording is performed using the ink set according the above aspect, the method including an ink attachment step, in which the ink jet ink composition is ejected by ink jet technology and attached to a recording medium; and a treatment liquid attachment step, in which the treatment liquid is attached to the recording medium, wherein the recording medium is a low- or non-absorbent recording medium.

### BRIEF DESCRIPTION OF THE DRAWINGS

FIG. 1 is an outline illustration of an example of an ink jet recording apparatus.

FIG. 2 is an outline illustration of the carriage and related components of an example of an ink jet recording apparatus.

FIG. 3 is a block diagram for an example of an ink jet recording apparatus.

### DESCRIPTION OF EXEMPLARY EMBODIMENTS

The following describes embodiments of the present disclosure. The following embodiments are descriptions of examples of the disclosure. The disclosure is never limited to these embodiments and includes variations implemented within the gist of the disclosure. Not all the configurations described below are essential for the disclosure.

### 1. Ink Set

An ink set according to an embodiment of an aspect of the present disclosure is one that includes a flocculant-containing treatment liquid and an ink jet ink composition, and is for use in recording on a low- or non-absorbent recording medium. The ink jet ink composition is a water-based ink containing at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C. The organic compound sparingly soluble in water includes a diol or glycol ether having a normal boiling point of 180° C. to 300° C., with the diol or glycol ether constituting 2.3% by mass or less of the total mass of the ink composition.

The ink set according to this embodiment includes an ink jet ink composition (hereinafter also referred to as “ink composition” or “ink”) that contains a particular organic compound sparingly soluble in water at a concentration equal to or smaller than a predetermined limit. By virtue of this, the ink set according to this embodiment combines great reduction of banding irregularities with superior storage stability of ink, despite including a treatment liquid and being for use in recording on a low- or non-absorbent recording medium.

As used herein, the term “ink set” refers to a set of an ink jet ink composition and a treatment liquid used for recording. In an ink set, the ink and the treatment liquid may be in separate liquid receptacles or may be in one single liquid receptacle.

An ink set includes at least one (kind of) ink jet ink composition and at least one (kind of) treatment liquid. An ink set may include two or more ink jet ink compositions or treatment liquids or may even include two or more of both.

An ink jet ink composition is a type of ink that is used for recording by being ejected from an ink jet head by ink jet technology.

The following first describes the recording medium on which the ink set according to this embodiment performs recording, and then components of the ink set, the ink jet ink composition and the treatment liquid.

### 1.1. Recording Medium

The ink set according to this embodiment is for use in recording on a low- or non-absorbent recording medium. On a low- or non-absorbent recording medium, ink does not spread smoothly (does not fill space on the recording medium well). Hence this type of recording often encounters the defect called banding irregularities, which are band-shaped irregularities on the recorded image, caused by slight variations in the quantity of ink droplets ejected from nozzles or minor misalignment of the landing position of the ink droplets. The ink set according to this embodiment, however, helps achieve great reduction of banding irregularities and superior storage stability of ink at the same time, despite being for use in recording on such a recording medium.

The term “low- or non-absorbent recording medium” refers to a recording medium that absorbs little or no liquid. Quantitatively, a low- or non-absorbent recording medium is one that absorbs 10 mL/m² or less water from the start of contact until 30 msec^{1/2} in the Bristow test. The Bristow test is the most common method for brief measurement of liquid absorption and has also been adopted by Japan Technical Association of the Pulp and Paper Industry (JAPAN TAPPI). The details of the test method are set forth in No. 51 of JAPAN TAPPI Test Method 2000, which specifies the Bristow test as a method for testing the absorption of liquid in paper and paperboards.

### Low-Absorbent Recording Medium

Any kind of low-absorbent recording medium can be used, but an example is coated paper, or paper having a coating layer for receiving ink on its surface. Any kind of coated paper can be used, but examples include types of paper for commercial printing, such as art paper, low coat-weight paper, and matte-coated paper. The coating layer is one that absorbs little ink, and an example is a coating of particles, for instance of an inorganic compound, spread with a binder.

### Non-Absorbent Recording Medium

Any kind of non-absorbent recording medium can be used, but examples include plastic, glass, metal, ceramic, and other similar recording media.

Examples of plastic recording media include plastic films. Examples of plastic films include a polyester film, a polyurethane film, a polycarbonate film, a polyphenylene sulfide film, a polyimide film, and a polyamide imide film. Films of polyolefins, such as polyethylene and polypropylene, and of polyvinyl chloride are also included. Biomass-based plastic films are also included, such as films of PLA, PBS, PHA, bio-PE, bio-PP, and bio-PET.

A plastic recording medium, furthermore, may be a film of a plastic material alone or may be one composed of a substrate, such as a piece of paper, and a plastic coating thereon or a plastic film joined thereto.

A metal recording medium may be a piece of metal alone, for example of iron, silver, copper, or aluminum, or one composed of a nonmetallic substrate, such as a plastic substrate, and a deposited layer of such a metal on the recording side of the substrate. In other words, a metal recording medium only needs to have a metal surface on its recording side.

Recording media that allow light to pass through, such as colorless and transparent, translucent, or colored and transparent ones, may also be used. Recording media that do not, such as chromatic and nontransparent or achromatic and nontransparent ones, also work. Materials like three-dimensional objects, such as sheet-shaped, spherical, or box-shaped ones, and paperware can also be used as recording media.

Of such low- or non-absorbent recording media, non-absorbent ones are particularly preferred as they benefit more from the advantages of this aspect of the present disclosure. Plastic recording media are more preferred. Banding irregularities are particularly frequent on these types of recording media, on which it is more difficult than on others for ink to spread. The ink set according to this embodiment, however, helps achieve great reduction of banding irregularities and superior storage stability of ink at the same time even on such a recording medium.

### 1.2. Ink Jet Ink Composition

A component of the ink set according to this embodiment, the ink jet ink composition is a water-based ink that contains at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C. The organic compound sparingly soluble in water includes a diol or glycol ether having a normal boiling point of 180° C. to 300° C., with the diol or glycol ether constituting 2.3% by mass or less of the total mass of the ink composition.

The following describes each ingredient in the ink jet ink composition as a component of the ink set according to this embodiment.

### 1.2.1. Colorant

The ink jet ink composition as a component of the ink set according to this embodiment contains at least one colorant. Pigment(s), dye(s), or both can be used.

### Pigments

Both inorganic and organic pigments can be used. Preferably, the colorant is pigment(s) as this can help improve the light fastness of the ink composition.

Inorganic pigments that can be used include carbon black (C.I. Pigment Black 7) pigments, such as furnace black, lamp black, acetylene black, and channel black, iron oxide, and titanium oxide.

As for organic ones, examples include azo pigments, such as insoluble azo pigments, condensed azo pigments, azo lakes, and chelate azo pigments, polycyclic pigments, such as phthalocyanine pigments, perylene and perinone pigments, anthraquinone pigments, quinacridone pigments, dioxane pigments, thioindigo pigments, isoindolinone pigments, and quinophthalone pigments, dye chelates (e.g., basic dye chelates and acid dye chelates), dye lakes (e.g., basic dye lakes and acid dye chelates), nitro pigments, nitroso pigment, aniline black, and daylight fluorescent pigments.

More specifically, examples of carbon black pigments, for black ink, include pigments like No. 2300, No. 900, MCF88, No. 33, No. 40, No. 45, No. 52, MA7, MA8, MA100, and No. 2200B (Mitsubishi Chemical Corporation), pigments like Raven 5750, Raven 5250, Raven 5000, Raven 3500, Raven 1255, and Raven 700 (Carbon Columbia), pigments like Regal 400R, Regal 330R, Regal 660R, Mogul L, Monarch 700, Monarch 800, Monarch 880, Monarch 900, Monarch 1000, Monarch 1100, Monarch 1300, and Monarch 1400 (CABOT JAPAN K. K.), and pigments like Color Black FW1, Color Black FW2, Color Black FW2V, Color Black FW18, Color Black FW200, Color Black 5150, Color Black 5160, Color Black S170, Printex 35, Printex U, Printex V, Printex 140U, Special Black 6, Special Black 5, Special Black 4A, and Special Black (Degussa).

Examples of pigments that can be used in white ink include C.I. Pigment White 6, 18, and 21.

Examples of pigments that can be used in yellow ink include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, and C.I. Pigment Yellow 180.

Examples of pigments that can be used in magenta ink include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48 (Ca), C.I. Pigment Red 48 (Mn), C.I. Pigment Red 57 (Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, and C.I. Pigment Red 245 and C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of pigments that can be used in cyan ink include C.I. Pigment Blue 1, C.I. Pigment Blue 2, C.I. Pigment Blue 3, C.I. Pigment Blue 15, C.I. Pigment Blue 15:1, C.I. Pigment Blue 15:2, C.I. Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of pigments other than magenta, cyan, and yellow ones include C.I. Pigment Green 7, C.I. Pigment Green 10, C.I. Pigment Brown 3, C.I. Pigment Brown 5, C.I. Pigment Brown 25, C.I. Pigment Brown 26, C.I. Pigment Orange 1, C.I. Pigment Orange 2, C.I. Pigment Orange 5, C.I. Pigment Orange 7, C.I. Pigment Orange 13, C.I. Pigment Orange 14, C.I. Pigment Orange 15, C.I. Pigment Orange 16, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 63.

One such pigment may be used alone, or two or more may be used in combination.

Preferably, the average diameter of particles of the pigment is 300 nm or less, more preferably from 50 nm to 200 nm. When having an average diameter of particles in any of these ranges, the pigments tend to be more reliable, for example by making the ejection of the ink composition more stable and dispersing better in the ink composition, and give the resulting image higher quality at the same time. Average diameters of particles mentioned herein are those measured by dynamic light scattering.

### Dispersed Pigment

Preferably, the pigment is present dispersed in the ink composition, or as a dispersed pigment. As used herein, the term dispersed pigment encompasses that is in a liquid dispersion and in a slurry (water-based dispersion of low viscosity).

Examples of dispersed pigments include, but are not limited to, a self-dispersible pigment, a polymer-dispersed pigment, and a pigment coated with a polymer.

### Self-Dispersible Pigment

A self-dispersible pigment is one that disperses or dissolves in an aqueous medium without a dispersant. In this context, “disperses or dissolves in an aqueous medium without a dispersant” means that without an agent for it to disperse, or without a dispersant, the pigment can exist in a stable state in the aqueous medium by virtue of hydrophilic groups on its surface. Dispersants affect foam breaking by the dispersions containing them, but this dispersant-free dispersion foams little, helping prepare an ink superior in ejection stability. A dispersion made with this type of pigment, furthermore, is easy to handle; for example, without a great increase in viscosity caused by a dispersant, the dispersion can contain more pigment and, therefore, will give the ink a sufficiently high printing density.

Preferably, the hydrophilic groups are of one or more types selected from the group consisting of —OM, —COOM, —CO—, —SO₃M, —SO₂M, —SO₂NH₂, —RSO₂M, —PO₃HM, —PO₃M₂, —SO₂NHCOR, —NH₃, and —NR₃.

In these chemical formulae, M represents a hydrogen atom, an alkali metal, ammonium, a substituted or unsubstituted phenyl group, or an organic ammonium, and R represents a C1 to C12 alkyl group or substituted or unsubstituted naphthyl group. Multiple Ms or Rs are independent of one another.

A self-dispersible pigment is produced by, for example, coupling (grafting) such hydrophilic groups to the surface of a pigment by physically or chemically treating the pigment. Examples of physical treatments include plasma treatment in a vacuum. Examples of chemical treatments include wet oxidation, which is to oxidize the pigment with an oxidant in water, and binding p-aminobenzoic acid to the surface of the pigment, which couples carboxylic groups to the surface with phenyl groups therebetween.

### Polymer-Dispersed Pigment

A polymer-dispersed pigment is one that disperses as a result of the dispersion of a polymer. Examples of preferred polymers for use in making a polymer-dispersible pigment include, but are not limited to, those having a glass transition temperature (Tg) of 55° C. or below, and those having a Tg of 50° C. or below are more preferred. A dispersant polymer, or a polymer used to disperse the pigment, having a Tg of 55° C. or below can help achieve good fixation of the ink.

Preferably, the weight-average molecular weight of the polymer as measured by gel permeation chromatography (GPC) is 10,000 or more and 200,000 or less. This can further improve the storage stability of the ink. The weight-average molecular weight (Mw) in this context can be measured as a polystyrene-equivalent weight-average molecular weight by gel permeation chromatography (GPC) with Hitachi, Ltd.'s L7100 system.

Preferably, 70% by mass or more of the polymer is a copolymer of a (meth)acrylate and a (meth)acrylic acid because in that case the ink tends to be better in fixation and gloss. Preferably, the polymer is one polymerized from monomers including at least one of a C1 to C24 alkyl (meth)acrylate or a C3 to C24 cyclic alkyl (meth)acrylate, with the (meth)acrylates constituting 70% by mass or more of the monomers. Specific examples of such monomers include, but are not limited to, methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, t-butylcyclohexyl (meth)acrylate, lauryl (meth)acrylate, isobornyl (meth)acrylate, cetyl (meth)acrylate, stearyl (meth)acrylate, isostearyl (meth)acrylate, tetramethylpyperidyl (meth)acrylate, dicyclopentanyl (meth)acrylate, dicyclopentanyl (meth)acrylate, dicyclopentenyloxy (meth)acrylate, and behenyl (meth)acrylate. Other monomers can also take part in the polymerization, including hydroxy, or hydroxyl-containing, (meth)acrylates, such as hydroxyethyl (meth)acrylate, hydroxypropyl (meth)acrylate, and diethylene glycol (meth)acrylate, urethane (meth)acrylates, and epoxy (meth)acrylates.

As used herein, the expression (meth)acrylic refers to at least one of acrylic or methacrylic. The expression (meth)acrylate refers to at least an acrylate or methacrylate.

Pigment Coated with a Polymer

Of polymer-dispersed pigments, pigments coated with a polymer, or microencapsulated pigments, are particularly preferred. When made with such a pigment, the ink tends to be superior in fixation, gloss, and color reproduction.

A pigment coated with a polymer is obtained by phase inversion emulsification. That is, a polymer as described above is dissolved in an organic solvent, such as methanol, ethanol, isopropanol, n-butanol, acetone, methyl ethyl ketone, or dibutyl ether. Adding the pigment to the resulting solution, then adding a neutralizing agent and water, and kneading and dispersing the mixture will give an oil-in-water dispersion. By removing the organic solvent from the resulting dispersion, a pigment coated with the polymer is obtained as a dispersion in water. The kneading and dispersion can be performed using, for example, a ball mill, roll mill, bead mill, high-pressure homogenizer, or high-speed stirring disperser.

Preferably, the neutralizing agent is, for example, ethyl amine, a tertiary amine, such as trimethyl amine, lithium hydroxide, sodium hydroxide, potassium hydroxide, or ammonia. Preferably, the resulting dispersion in water has a pH of 6 to 10.

Preferably, the polymer for coating the polymer with is one having a weight-average molecular weight of about 10,000 to 150,000 as measured by GPC. This helps disperse the pigment in a stable manner.

### Dyes

Any type of dye can be used, and examples of types that can be used include acid dyes, direct dyes, reactive dyes, and basic dyes. Examples of dyes include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, 195, C.I. Reactive Red 14, 32, 55, 79, and 249, and C.I. Reactive Black 3, 4, and 35.

One such dye may be used alone, or two or more may be used in combination.

Preferably, the colorant content (on a solids basis) is 1% by mass or more, more preferably 2% by mass or more, even more preferably 3% by mass or more of the total mass of the ink composition. Preferably, the colorant content (on a solids basis) is 10% by mass or less, more preferably 8% by mass or less, even more preferably 6% by mass or less of the total mass of the ink composition. The ink can be better in storage stability when its colorant content is in any of these ranges.

### 1.2.2. Water

The ink jet ink composition as a component of the ink set according to this embodiment is a water-based one (water-based ink) and therefore contains water. A “water-based” composition is a composition containing water as its primary solvent.

Examples of types of water include those with reduced levels of ionic impurities, such as deionized water, ultrafiltered water, reverse osmosis water, distilled water, and other types of purified water and ultrapure water. Using sterilized water, for example sterilized by ultraviolet irradiation or adding hydrogen peroxide, helps control the development of molds and bacteria when the ink jet ink composition is stored long.

Preferably, the water content is 40% by mass or more, more preferably 45% by mass or more, even more preferably 50% by mass or more, in particular 60% by mass or more of the total mass of the ink composition. There is no particular upper limit, but by way of example, it is preferred that the water content be 90% by mass or less of the total mass of the ink composition. More preferably, the water content is 85% by mass or less, even more preferably 80% by mass or less.

### 1.2.3. Water-Soluble Organic Compound

The ink jet ink composition as a component of the ink set according to this embodiment is a water-based ink containing at least one water-soluble organic compound, having a solubility of more than 10 g in 100 g of water at 20° C. Water-soluble organic compounds include those that are liquid at room temperature and those that are solid at room temperature. By virtue of containing a water-soluble organic compound, the ink is superior in recovery from clogging, storage stability, and image quality.

The solubility of a candidate water-soluble organic compound can be determined as follows. First, a predetermined amount of the organic compound is mixed and stirred with 100 g of water for 30 minutes under 20° C. conditions. A compound that is liquid at room temperature is considered dissolved when there is no phase separation or sea-island structure after the stirring. A compound that is solid at room temperature is considered dissolved when there is no undissolved residue after the stirring.

Different amounts of organic compounds are mixed with 100 g of water in such a way, and the largest amount at which the compound is considered dissolved is reported as its solubility. When the solubility is more than 10 g, the organic compound is a water-soluble one.

It should be noted that a water-soluble organic compound can be a compound completely miscible with water or can be a compound miscible with water.

As used herein, the term “completely miscible with water” means that water and the organic compound are soluble in each other, or that the organic solvent has infinite solubility in 100 g of water in 20° C. The term “miscible with water” means that water and the organic solvent are soluble in each other only to a particular limit, and that the solubility of the organic compound in 100 g of water at 20° C. is more than 10 g.

Preferably, the molecular weight of the water-soluble organic compound is 500 or less as a weight average. It is more preferred that the molecular weight be 400 or less, even more preferably 300 or less.

Preferably, the ink jet ink composition contains a water-soluble organic compound having a normal boiling point of 150° C. to 350° C., more preferably 150° C. to 300° C. Preferably, water-soluble organic compounds include one having a melting point of 90° C. or below, more preferably 80° C. or below. Preferably, the melting point is −70° C. or above.

There is no upper limit to the solubility of the water-soluble organic compound as long as it is more than 10 g; it may be infinity. Preferably, the solubility is 11 g or more, more preferably 50 g or more.

Examples of water-soluble organic compounds, having a solubility of more than 10 g in 100 g of water at 20° C., include resin-dissolving substances, polyols, glycol ethers, and alkanolamines. A resin-dissolving substance is an amide, sulfur-containing solvent, or cyclic ether.

Of these, resin-dissolving substances, polyols, and glycol ethers are particularly preferred.

More preferably, the water-soluble organic compound is, for example, a resin-dissolving substance that is an amide, sulfur-containing solvent, or cyclic ether having a normal boiling point of 150° C. to 300° C. or any compound in the category of polyols or glycol ethers having a normal boiling point of 150° C. to 250° C. Other water-soluble organic compounds may optionally be contained.

Preferably, the water-soluble organic compound constitutes 40% by mass or less of the total mass of the ink composition. Preferably, the water-soluble organic compound constitutes 1% by mass or more of the total mass of the ink composition. It is more preferred that the concentration of the water-soluble organic compound be from 5% to 30% by mass, even more preferably from 10% to 25% by mass.

### Resin-Dissolving Substances

Examples of water-soluble organic compounds, having a solubility of more than 10 g in 100 g of water at 20° C., include resin-dissolving substances that are amides, sulfur-containing solvents, or cyclic ethers. Of these, it is particularly preferred that the ink composition contain a resin-dissolving substance that is an amide, sulfur-containing solvent, or cyclic ether having a normal boiling point of 150° C. to 300° C. A resin-dissolving substance is an organic compound that dissolves resins, which provides improved abrasion resistance, but this is not the only function this type of substance can have.

Examples of amides include cyclic amides (lactams), such as 2-pyrrolidone (2P), 2-piperidone, ε-caprolactam (CPL), N-methyl-ε-caprolactam, N-cyclohexyl-2-pyrrolidone, N-methylpyrrolidone, N-ethylpyrrolidone, N-butylpyrrolidone, 5-methyl-2-pyrrolidone, β-propiolactam, and ω-heptalactam, and linear amides, such as N,N-dimethylacetoacetamide, N,N-diethylacetoacetamide, N-methylacetoacetamide, N,N-dimethylisobutylamide, N,N-dimethylformamide, N,N-diethylformamide, N,N-dimethylacetamide, N,N-diethylacetamide, N,N-dimethylpropionamide, 3-methoxy-N,N-dimethylpropanamide (DMPA), 3-n-butoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide. Of these, 2-pyrrolidone (2P), ε-caprolactam (CPL), and 3-methoxy-N,N-dimethylpropanamide (DMPA) are more preferred than the others; when made with any of these, the ink tends to be better in storage stability.

Examples of sulfur-containing solvents include 3-methylsulfolane, sulfolane, ethylisopropylsulfone, ethylmethylsulfone, dimethylsulfone, dimethylsulfoxide (DMSO), diethylsulfoxide, tetramethylene sulfoxide, and methylphenylsulfoxide. Of these, dimethylsulfoxide (DMSO) is more preferred than the others; when made with it, the ink tends to be better in storage stability.

Examples of cyclic ethers include isosorbide dimethyl ether, 3-methyl-3-oxetanemethanol, 3-ethyl-3-oxetanemethanol (DMHD), 2-hydroxymethyloxetane, tetrahydrofurfuryl alcohol, solketal, glycerol formal, 1,4-dioxane-2,3-diol, and dihydrolevoglucosenone. Of these, 3-ethyl-3-oxetanemethanol (DMHD) is more preferred than the others; when made with it, the ink tends to be better in storage stability.

Of these, resin-dissolving substances that are amides and have a normal boiling point of 150° C. to 300° C. are particularly preferred because with any such resin dissolving substance, the ink tends to be better in storage stability. Preferably, the melting point of the resin-dissolving substance is 80° C. or below. The ink tends to be better in recovery from clogging when containing a resin-dissolving substance with a melting point in this range.

Preferably, the ink jet ink composition as a component of the ink set according to this embodiment contains, as a water-soluble organic compound, a resin-dissolving substance that is an amide, sulfur-containing solvent, or cyclic ether, with the substance constituting 20% by mass or less of the total mass of the ink composition. It is more preferred that the concentration of the resin-dissolving substance be 15% by mass or less, even more preferably 10% by mass or less, in particular 5% by mass or less. As for the lower limit, the concentration of the resin-dissolving substance is 0% by mass or more, preferably 1% by mass or more, more preferably 2% by mass or more, even more preferably 3% by mass or more.

Alternatively, the concentration of a resin-dissolving substance that is an amide, sulfur-containing solvent, or cyclic ether and has a normal boiling point of 150° C. to 300° C. may be in any of these ranges.

When containing such a resin-dissolving substance at a concentration in any of these ranges, the ink composition tends to be better in storage stability and abrasion resistance by virtue of good compatibility between the water-soluble organic compound and the organic compound sparingly soluble in water inside it. Using such a resin-dissolving substance at a concentration beyond these ranges will affect storage stability or cause banding irregularities not to be reduced as expected, presumably because it will make the organic compound sparingly soluble in water more insoluble by reducing the relative amount of water in the ink composition.

### Polyols and Glycol Ethers

Preferably, the ink jet ink composition as a component of the ink set according to this embodiment contains, as a water-soluble organic compound that is not a resin-dissolving substance, any compound in the category of polyols or glycol ethers.

It is particularly preferred that the ink jet ink composition contain any compound in the category of polyols or glycol ethers having a normal boiling point of 150° C. to 250° C.

### Polyols

When the compound is a polyol, it is preferred that it be a glycol or product of condensation between hydroxyl groups of glycol molecules. In that case, the compound has two hydroxyl groups.

An alternative example is a hydroxyl-substituted derivative of a glycol or product of condensation between hydroxyl groups of glycol molecules. In that case, the compound has three or more hydroxyl groups.

Preferably, the number of carbon atoms in the glycol or in the glycol unit in the product of condensation between hydroxyl groups of glycol molecules is from 2 to 10, more preferably from 3 to 8. Preferably, the number of carbon atoms in the entire polyol molecule is from 2 to 15, more preferably from 3 to 10.

Preferably, the polyol has a normal boiling point of 150° C. to 250° C.

Examples of polyols having a normal boiling point of 150° C. to 250° C. include ethylene glycol (normal boiling point, 198° C.; miscible with water), diethylene glycol (normal boiling point, 244° C.; completely miscible with water), 1,2-propanediol (propylene glycol) (normal boiling point, 188° C.; completely miscible with water), dipropylene glycol (normal boiling point, 227° C.; completely miscible with water), 1,2-butanediol (normal boiling point, 193° C.; miscible with water), 1,2-pentanediol (normal boiling point, 210° C.; miscible with water), 1,2-hexanediol (normal boiling point, 224° C.; completely miscible with water), 1,3-propanediol (normal boiling point, 214° C.; completely miscible with water), 1,4-butanediol (normal boiling point, 228° C.; completely miscible with water), 2,3-butanediol (normal boiling point, 177° C.; miscible with water), 1,3-butylene glycol (normal boiling point, 207° C.; completely miscible with water), 3-methyl-1,3-butanediol (normal boiling point, 203° C.; completely miscible with water), 2-methyl-1,3-propanediol (normal boiling point, 214° C.; completely miscible with water), 2,2-dimethyl-1,3-propanediol (normal boiling point, 208° C.; solubility, 83 [g/100 g of water]), 2-methylpentane-2,4-diol (normal boiling point, 197° C.; completely miscible with water), 2,5-dimethyl-2,5-hexanediol (normal boiling point, 218° C.; solubility, 14 [g/100 g of water]), 1,5-pentanediol (normal boiling point, 242° C.; miscible with water), 3-methyl-1,5-pentanediol (normal boiling point, 250° C.; completely miscible with water), and 1,6-hexanediol (normal boiling point, 250° C.; miscible with water). Polyols having ten or fewer carbon atoms are more preferred.

Of polyols, alkanediols having ten or fewer carbon atoms and a normal boiling point of 150° C. to 250° C. are more preferred than the others, and alkanediols having six or fewer carbon atoms and a normal boiling point of 150° C. to 250° C. are even more preferred. Examples of alkanediols include 1,2-alkanediols, such as ethylene glycol, propylene glycol, 1,2-propanediol, 1,2-butanediol, 1,2-penetanediol, and 1,2-hexanediol, 1,3-propanediol, and 1,3-butylene glycol.

### Glycol Ethers

Glycol ethers are compounds produced when one or both hydroxyl groups of glycols form an ether. When the compound is a glycol ether, it is preferred that it be a monoether or diether of an alkylene glycol. Preferably, the ether(s) formed by the alkylene glycol is alkyl ether(s). Preferably, the number of carbon atoms in the alkylene in the alkylene glycol and that in the alkyl(s) in the alkyl ether(s) are each independently from 1 to 5, more preferably from 2 to 4. Glycol ethers having a normal boiling point of 150° C. to 250° C. are preferred.

Examples of glycol ethers include alkylene glycol monoalkyl ethers, such as ethylene glycol monomethyl ether (completely miscible with water), ethylene glycol monoethyl ether (miscible with water), ethylene glycol monoisopropyl ether (solubility, 100 [g/100 g of water]), ethylene glycol monopropyl ether (miscible with water), ethylene glycol monoisobutyl ether (solubility, 75.5 [g/100 g of water]), ethylene glycol mono-tert-butyl ether (miscible with water), ethylene glycol monobutyl ether (solubility, 100 [g/100 g of water]), diethylene glycol monomethyl ether (completely miscible with water), diethylene glycol monoethyl ether (completely miscible with water), diethylene glycol monoisopropyl ether (miscible with water), diethylene glycol monoisobutyl ether (completely miscible with water), diethylene glycol monobutyl ether (completely miscible with water), triethylene glycol monomethyl ether (completely miscible with water), triethylene glycol monoethyl ether (completely miscible with water), triethylene glycol monobutyl ether (miscible with water), tetraethylene glycol monomethyl ether (miscible with water), propylene glycol monomethyl ether (miscible with water), propylene glycol monoethyl ether (completely miscible with water), propylene glycol monopropyl ether (miscible with water), dipropylene glycol monomethyl ether (completely miscible with water), dipropylene glycol monopropyl ether (solubility, 19 [g/100 g of water]), tripropylene glycol monomethyl ether (completely miscible with water), 1,3-propanediol monomethyl ether (3-methoxy-1-propanol) (completely miscible with water), and 1,3-butylene glycol-3-monomethyl ether (3-methoxy-1-butanol) (miscible with water), and alkylene glycol dialkyl ethers (glymes), such as ethylene glycol dimethyl ether (completely miscible with water), diethylene glycol dimethyl ether (completely miscible with water), diethylene glycol methyl ethyl ether (completely miscible with water), diethylene glycol diethyl ether (completely miscible with water), triethylene glycol dimethyl ether (completely miscible with water), tetraethylene glycol dimethyl ether (completely miscible with water), dipropylene glycol dimethyl ether (solubility, 52.6 [g/100 g of water]), and tripropylene glycol dimethyl ether (solubility, 23.6 [g/100 g of water]).

In improving the abrasion resistance of the image formed, diethers are more preferred than monoethers because diethers tend to be more capable than monoethers of dissolving or swelling resins in the ink. For smooth spread of the ink, monoethers are preferred.

Preferably, the ink jet ink composition as a component of the ink set according to this embodiment contains, as a water-soluble organic compound, a polyol or glycol ether, with the polyol or glycol ether constituting 30% by mass or less, more preferably 25% by mass or less, of the total mass of the ink composition. As for the lower limit, the concentration of the polyol or glycol ether is 0% by mass or more, preferably 10% by mass or more, more preferably 15% by mass or more of the total mass of the ink composition.

It is, furthermore, preferred that the concentration of a polyol or glycol ether having a normal boiling point of 150° C. to 250° C. be in any of these ranges.

When containing such a water-soluble organic compound at a concentration in any of these ranges, the ink composition tends to be better in storage stability by virtue of good compatibility between the water-soluble organic compound and the organic compound sparingly soluble in water. Of polyols having a normal boiling point of 150° C. to 250° C., the aforementioned alkanediols having ten or fewer carbon atoms and a normal boiling point of 150° C. to 250° C. are more preferred than the others.

Preferably, the ink jet ink composition as a component of the ink set according to this embodiment contains, as a water-soluble organic compound, an alkanediol having six or fewer carbon atoms and having a normal boiling point of 150° C. to 250° C., with the alkanediol constituting 10% to 25% by mass, more preferably 12% to 20% by mass, even more preferably 15% to 18% by mass of the total mass of the ink composition. When containing such a water-soluble organic compound at a concentration in any of these ranges, the ink composition tends to be even better in storage stability by virtue of better compatibility between the water-soluble organic compound and the organic compound sparingly soluble in water.

### Other Compounds

The ink jet ink composition as a component of the ink set according to this embodiment may optionally contain other water-soluble organic compounds.

### Alkanolamines

The ink jet ink composition may contain, as a water-soluble organic compound, an alkanolamine. Alkanolamines are compounds having an alkane backbone with hydroxyl and amino groups on it. The alkanolamine has in its molecule one or more hydroxyl groups, preferably one to five, more preferably two or three. Preferably, the number of carbon atoms in the alkanolamine molecule is from 1 to 20, more preferably from 2 to 10, even more preferably from 6 to 9. As for the alkane backbone, that having one to six carbon atoms is preferred, and that having two to four is more preferred. The alkanolamine has in its molecule one or more amino groups, preferably one to five, more preferably one or two.

Any kind of alkanolamine can be used, but examples include

ethanolamine (miscible with water), N-methylethanolamine (solubility, 100 [g/100 g of water]), N,N-dimethylethanolamine (completely miscible with water), N-ethylethanolamine (miscible with water), N-butylethanolamine (miscible with water), N,N-diethylethanolamine (miscible with water), diethanolamine (solubility, 100 [g/100 g of water]), N-methyldiethanolamine (solubility, 100 [g/100 g of water]), N-ethyldiethanolamine (miscible with water), N-butyldiethanolamine (miscible with water), N-tert-butyldiethanolamine (completely miscible with water), triethanolamine (completely miscible with water), isopropanolamine (miscible with water), N,N-dimethylisopropanolamine (completely miscible with water), N,N-diethylisopropanolamine (miscible with water), diisopropanolamine (solubility, 87 [g/100 g of water]), triisopropanolamine (solubility, 83 [g/100 g of water]), N,N-dimethylpropanolamine (miscible with water), 2-amino-1-propanol (completely miscible with water), 2-amino-2-methyl-1-propanol (completely miscible with water), 5-amino-1-pentanol (miscible with water), 2-amino-2-methyl-1,3-propanediol (miscible with water), 2-amino-2-hydroxymethyl-1,3-propanediol (miscible with water), 3-amino-1,2-propanediol (miscible with water), 3-methylamino-1,2-propanediol (completely miscible with water), tripropanolamine, and tributanolamine. Of these, triethanolamine and triisopropanolamine are particularly preferred, and triisopropanolamine is more preferred. One alkanolamine may be used alone, or two or more may be used in combination.

Preferably, the percentage of the alkanolamine to the total mass of the ink composition is 1% by mass or less, more preferably from 0.05% to 0.5% by mass.

### Polyols Having a Normal Boiling Point Higher Than 280° C.

The ink jet ink composition may contain, as water-soluble organic compounds, polyols having a normal boiling point higher than 280° C., but preferably with the polyols constituting not more than 3% by mass of the total mass of the ink composition. More preferably, the concentration of such polyols is not higher than 1% by mass, even more preferably not higher than 0.5% by mass.

The ink may contain polyols having a normal boiling point higher than 280° C. or may be free of them. When it does, the concentration is equal to or below any of the above limits. When the concentration of polyols having a normal boiling point higher than 280° C. is in any of these ranges, the speed of drying of the ink is not significantly affected. The fixation of the image, therefore, tends not to be impaired, even though the ink is for recording on low- or non-absorbent recording media. The ink, furthermore, tends to dry sufficiently even when the temperature for heat drying of the recording medium is relatively low. Examples of polyols having a normal boiling point higher than 280° C. include glycerol (normal boiling point, 290° C.). Alkanolamines, such as triisopropanolamine, are excluded.

### 1.2.4. Organic Compound Sparingly Soluble in Water

The ink jet ink composition as a component of the ink set according to this embodiment is a water-based ink containing at least one organic compound sparingly soluble in water, having a solubility of 0.1 to 10 g in 100 g of water at 20° C. The organic compound sparingly soluble in water includes a diol or glycol ether having a normal boiling point of 180° C. to 300° C., with the diol or glycol ether constituting 2.3% by mass or less of the total mass of the ink composition.

By virtue of this, the ink set helps reduce banding irregularities on low- or non-absorbent recording media greatly. The ink, furthermore, is superior in storage stability and abrasion resistance. Of particular note is that banding irregularities are greatly reduced on non-absorbent recording media, such as plastic films, on which banding irregularities are relatively frequent.

Although there may be other reasons, this presumably owes to the fact that compounds sparingly soluble in water are generally hydrophobic. This type of compound, therefore, is highly compatible with low- or non-absorbent recording media and tends to spread smoothly on them. An ink containing such a compound also spreads well on these types of recording media, and banding irregularities are reduced greatly.

The solubility of a candidate organic compound sparingly soluble in water can be determined in the same way as that of a candidate water-soluble organic compound (described above). When the solubility is from 0.1 to 10 g, the organic compound is sparingly soluble in water.

An example of an organic compound sparingly soluble in water is a diol or glycol ether having a solubility of 0.1 to 10 g in 100 g of water at 20° C. and a normal boiling point of 180° C. to 300° C. Other organic compounds sparingly soluble in water may optionally be used.

Preferably, the organic compound sparingly soluble in water has a weight-average molecular weight of 500 or less. It is more preferred that the weight-average molecular weight be 400 or less, even more preferably 300 or less.

Preferably, the melting point of the organic compound sparingly soluble in water is 130° C. or below, preferably −120° C. or above. It is more preferred that the melting point be from −50° C. to 60° C., even more preferably from −30° C. to 50° C.

Preferably, the normal boiling point of the organic compound sparingly soluble in water is from 200° C. to 280° C., more preferably from 230° C. to 270° C.

### Diols

Examples of diols having a solubility of 0.1 to 10 g in 100 g of water at 20° C. and a normal boiling point of 180° C. to 300° C. include 1,3-alkanediols, other aliphatic diols, and alicyclic diols.

Examples of 1,3-alkanediols include 2,2-diethyl-1,3-propanediol (DEPOD; boiling point, 240° C.; solubility, 10.0 [g/100 g of water]), 2-methyl-2-propyl-1,3-propanediol (MPPD; boiling point, 230° C.; melting point, 57° C.; solubility, 7.5 [g/100 g of water]), 2-butyl-2-ethyl-1,3-propanediol (BEPD; boiling point, 264° C.; melting point, 43° C.; solubility, 0.9 [g/100 g of water]), 2,2-diisobutyl-1,3-propanediol (DIBPD; boiling point, 253° C.; melting point, 77° C.; solubility, 0.5 [g/100 g of water]), 2,2-dibutyl-1,3-propanediol (DBPD; boiling point, 269° C.; solubility, 0.2 [g/100 g of water]), 2,2,4-trimethyl-1,3-pentanediol (TMPD; boiling point, 232° C.; melting point, 54° C.; solubility, 1.9 [g/100 g of water]), and 2-ethyl-1,3-hexanediol (EHD; boiling point, 244° C.; melting point, −40° C.; solubility, 4.2 [g/100 g of water]).

Examples of other aliphatic diols include 1,2-octanediol (1,2OD; boiling point, 267° C.; melting point, 26° C.; solubility, 0.8 [g/100 g of water]), 1,9-nonanediol (1,9ND; boiling point, 289° C.; melting point, 46° C.; solubility, 0.6 [g/100 g of water]), and 2,4-diethyl-1,5-pentanediol (DEPD; boiling point, 257° C.; liquid (25° C.); solubility, 1.0 [g/100 g of water]).

Examples of alicyclic diols include 2,2,4,4-tetramethyl-1,3-cyclobutanediol (TMCD; boiling point, 220° C.; melting point, 126° C.; solubility, 6.1 [g/100 g of water]) and 1,4-cyclohexanedimethanol (CHDM; boiling point, 286° C.; melting point, 35° C.; solubility, 0.8 [g/100 g of water]).

Of such diols having a normal boiling point of 180° C. to 300° C., 1,3-alkanediols represented by general formula (1) and alicyclic diols are particularly preferred:

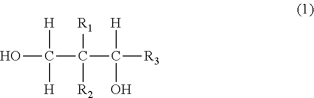

(where each of R₁, R₂, and R₃ is independently hydrogen or an alkyl group, and the total number of carbon atoms in R₁, R₂, and R₃ is from 3 to 9).

Preferably, in this formula, at least one of R₁ or R₂ is not hydrogen. When R₁, R₂, and R₃ are alkyl groups, it is preferred that they each independently have one to five carbon atoms, more preferably two to four. Preferably, the total number of carbon atoms in R₁, R₂, and R₃ is 4 or 5, more preferably from 4 to 6. It is preferred that R₃ be an alkyl group.

Examples of 1,3-alkanediols represented by general formula (1) and alicyclic diols include 2-methyl-2-propyl-1,3-propanediol (MPPD), 2-butyl-2-ethyl-1,3-propanediol (BEPD), 2,2,4-trimethyl-1,3-pentanediol (TMPD), and 2-ethyl-1,3-hexanediol (EHD).

When the diol having a normal boiling point of 180° C. to 300° C. is a 1,3-alkanediol represented by general formula (1) or alicyclic diol, the ink tends to be better in the reduction of banding irregularities and abrasion resistance.

### Glycol Ethers

Examples of glycol ethers having a solubility of 0.1 to 10 g in 100 g of water at 20° C. and a normal boiling point of 180° C. to 300° C. include glycol monoethers and glycol diethers.

Examples of glycol monoethers include ethylene glycol monohexyl ether (EGHE; boiling point, 208° C.; melting point, −45° C.; solubility, 1.0 [g/100 g of water]), ethylene glycol mono-2-ethylhexyl ether (EHG; boiling point, 229° C.; melting point, −105° C.; solubility, 0.1 [g/100 g of water]), diethylene glycol monohexyl ether (HDG; boiling point, 259° C.; liquid (25° C.); solubility, 1.7 [g/100 g of water]), diethylene glycol mono-2-ethylhexyl ether (EHDG; boiling point, 277° C.; melting point, −82° C.; solubility, 0.5 [g/100 g of water]), dipropylene glycol monobutyl ether (BPDG; boiling point, 230° C.; liquid (25° C.); solubility, 4.0 [g/100 g of water]), and tripropylene glycol monobutyl ether (BPTG; boiling point, 276° C.; solubility, 4.0 [g/100 g of water]).

Examples of glycol diethers include diethylene glycol butyl methyl ether (BMTG; boiling point, 212° C.; liquid (25° C.) and diethylene glycol dibutyl ether (DBDG; boiling point, 256° C.; melting point, −60° C.; solubility, 0.3 [g/100 g of water]).

Of such glycol ethers having a normal boiling point of 180° C. to 300° C., glycol ethers having six or more carbon atoms are particularly preferred. Examples of glycol ethers having six or more carbon atoms include ethylene glycol monohexyl ether (EGHE), ethylene glycol mono-2-ethylhexyl ether (EHG), diethylene glycol monohexyl ether (HDG), diethylene glycol mono-2-ethylhexyl ether (EHDG), dipropylene glycol monobutyl ether (BPDG), tripropylene glycol monobutyl ether (BPTG), diethylene glycol butyl methyl ether (BMTG), and diethylene glycol dibutyl ether (DBDG).

When the glycol ether is such a glycol ether having six or more carbon atoms, the ink tends to be better in the reduction of banding irregularities and storage stability.

Preferably, the glycol ether is ethylene glycol monohexyl ether (EGHE), ethylene glycol mono-2-ethylhexyl ether (EHG), diethylene glycol monohexyl ether (HDG), diethylene glycol mono-2-ethylhexyl ether (EHDG), or diethylene glycol dibutyl ether (DBDG). When the glycol ether is any of these, the ink tends to be superb in the reduction of banding irregularities and storage stability.

The ink jet ink composition as a component of the ink set according to this embodiment contains, as an organic compound sparingly soluble in water, a diol or glycol ether having a normal boiling point of 180° C. to 300° C., with the diol or glycol ether constituting 2.3% by mass or less of the total mass of the ink composition. Preferably, the concentration is from 0.1% to 2.0% by mass, more preferably from 0.15% to 1.5% by mass, even more preferably from 0.25% to 1.0% by mass, in particular from 0.35% to 0.7% by mass. Using such an organic compound sparingly soluble in water at a concentration in any of these ranges will ensure good reduction of banding irregularities. With such a compound at any of these ranges, furthermore, the ink tends to be better in storage stability.

### 1.2.5. Other Ingredients

Besides the ingredients described above, the ink jet ink composition as a component of the ink set according to this embodiment may optionally contain resin, wax, a defoamer, a surfactant, and/or other additives.

### Resin

The ink jet ink composition as a component of the ink set according to this embodiment may contain resin. The resin can be contained as a water-soluble resin or an emulsion of resin particles. When a pigment ink containing such a resin is attached to a recording medium, the resin can function as a fixing resin, or to improve the adhesion and abrasion resistance of the ingredients of the ink. An emulsion of resin particles is preferred.

Examples of resins include urethane, acrylic, fluorene, polyolefin, rosin-modified, terpene, polyester, polyamide, epoxy, vinyl chloride, ethylene-vinyl acetate, vinyl acetate, butadiene, styrene, crosslinked acrylic, crosslinked styrene, benzoguanamine, phenolic, silicone, epoxy, and paraffin resins and fluoropolymers. These resins are often handled in emulsion form, but the resin in this embodiment may be a powder. One kind of resin alone or two or more in combination can be used.

Resins that have a urethane bond are collectively referred to as urethane resins. They also include resins that contain a non-urethane bond, such as polyether urethane resins, which contain an ether bond in their backbone, polyester urethane resins, which contain an ester bond in their backbone, and polycarbonate urethane resins, which contain a carbonate bond in their backbone. Commercially available urethane resins can also be used. For example, one or more may be selected from commercially available urethane resins such as SUPERFLEX 210, 460, 460s, 840, and E-4000 (trade names, DKS Co., Ltd.), RESAMINE D-1060, D-2020, D-4080, D-4200, D-6300, and D-6455 (trade names, Dainichiseika Color & Chemicals Mfg. Co., Ltd.), Takelac WS-6020, WS-6021, and W-512-A-6 (trade names, Mitsui Chemicals Polyurethanes, Inc.), Sancure 2710 (trade name, LUBRIZOL), and PERMARIN UA-150 (trade name, Sanyo Chemical Industries).

Polymers obtained by polymerizing at least an acrylic monomer, such as (meth)acrylic acid or a (meth)acrylate, are collectively referred to as acrylic resins. Examples include resins obtained from acrylic monomers and copolymers of acrylic and other monomers. Examples of the latter include acryl-vinyl resins, which are copolymers of acrylic and vinyl monomers, such as copolymers of an acrylic monomer and styrene or a similar vinyl monomer. Acrylamide and acrylonitrile, for example, are also acrylic monomers that can be used.

Commercially available resin emulsions made with an acrylic resin can also be used. For example, one or more may be selected from products such as FK-854 (trade name, Chuo Rika Kogyo), Mowinyl 952B and 718A (trade names, the Nippon Synthetic Chemical Industry), Nipol LX852 and LX874 (trade names, Zeon), POLYSOL AT860 (Showa Denko K.K.), and VONCOAT AN-1190S, YG-651, AC-501, AN-1170, and 4001 (trade names, DIC; acrylic resin emulsions).

As mentioned, the category of acrylic resins herein includes styrene-acrylic resins. As used herein, the expression (meth)acrylic herein refers to at least one of acrylic and methacrylic.

Styrene-acrylic resins are copolymers of the styrene monomer and an acrylic monomer. Examples include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. Commercially available styrene-acrylic resins can also be used. Examples include Joncryl 62J, 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, BASF) and Mowinyl 966A and 975N (trade names, the Nippon Synthetic Chemical Industry).

The category of vinyl chloride resins includes vinyl chloride-vinyl acetate copolymers.

Polyolefin resins are resins that have an olefin, such as ethylene, propylene, or butylene, as their structural backbone, and suitable one(s) can be selected from known ones. Commercially available polyolefin resins can be used. For example, one or more may be selected from products such as ARROWBASE CB-1200 and CD-1200 (trade names, UNITIKA Ltd.).

Resins supplied in emulsion form may also be used. Examples of commercially available resin emulsions include MICROGEL E-1002 and E-5002 (trade names of Nippon Paint products, styrene-acrylic resin emulsions), VONCOAT AN-1190S, YG-651, AC-501, AN-1170, 4001, and 5454 (trade names of DIC products, styrene-acrylic resin emulsions), POLYSOL AM-710, AM-920, AM-2300, AP-4735, AT-860, and PSASE-4210E (acrylic resin emulsions), POLYSOL AP-7020 (styrene-acrylic resin emulsion), POLYSOL SH-502 (vinyl acetate resin emulsion), POLYSOL AD-13, AD-2, AD-10, AD-96, AD-17, and AD-70 (ethylene-vinyl acetate resin emulsions), POLYSOL PSASE-6010 (ethylene-vinyl acetate resin emulsion) (trade names of Showa Denko products), POLYSOL SAE1014 (trade name, a styrene-acrylic resin emulsion, Zeon), SAIVINOL SK-200 (trade name, an acrylic resin emulsion, Saiden Chemical Industry), AE-120A (trade name of a JSR product, an acrylic resin emulsion), AE373D (trade name of an Emulsion Technology product, a carboxy-modified styrene-acrylic resin emulsion), SEIKADYNE 1900W (trade name of a Dainichiseika Color & Chemicals Mfg. product, an ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid-acrylic resin emulsion) (trade names of Nissin Chemical Industry products), VINYBLAN 700 and 2586 (Nissin Chemical Industry), elitel KA-5071S, KT-8803, KT-9204, KT-8701, KT-8904, and KT-0507 (trade names of Unitika products, polyester resin emulsions), Hytec SN-2002 (trade name of a Toho Chemical product, a polyester resin emulsion), Takelac W-6020, W-635, W-6061, W-605, W-635, and W-6021 (trade names of Mitsui Chemicals Polyurethanes products, urethane resin emulsions), SUPERFLEX 870, 800, 150, 420, 460, 470, 610, 620, and 700 (trade names of DKS products, urethane resin emulsions), PERMARIN UA-150 (Sanyo Chemical Industries, Ltd., a urethane resin emulsion), Sancure 2710 (Lubrizol Japan, a urethane resin emulsion), NeoRez R-9660, R-9637, and R-940 (Kusumoto Chemicals Ltd., urethane resin emulsions), ADEKA BONTIGHTER HUX-380 and 290K (ADEKA Corporation, urethane resin emulsions), Mowinyl 966A and Mowinyl 7320 (Nippon Synthetic Chemical), Joncryl 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (BASF), NK Binder R-5HN (Shin-Nakamura Chemical Co., Ltd.), HYDRAN WLS-210 (non-crosslinked polyurethane; DIC Corporation), and Joncryl 7610 (BASF).

Of such resins, acrylic resins are particularly preferred, and styrene-acrylic resins are more preferred. With such a resin, the ink tends to be better in abrasion resistance.

Preferably, the glass transition temperature (Tg) of the resin is 60° C. or above, more preferably 70° C. or above, even more preferably 80° C. or above, in particular 90° C. or above. Preferably, the Tg of the resin is 120° C. or below, more preferably 115° C. or below, even more preferably 110° C. or below, in particular 105° C. or below. Using a resin having a glass transition temperature (Tg) in any of these ranges can help further reduce banding irregularities. With such a resin, furthermore, the ink can be better in abrasion resistance.

The glass transition temperature (Tg) of resin can be checked by measuring it, for example by differential scanning calorimetry (DSC).

Preferably, the resin content on a solids basis is 0.1% by mass or more and 20% by mass or less, more preferably 1.0% by mass or more and 15.0% by mass or less, even more preferably 2.0% by mass or more and 10.0% by mass or less, in particular 3.0% by mass or more and 8.0% by mass or less of the total mass of the ink composition.

### Wax

The ink jet ink composition as a component of the ink set according to this embodiment may contain wax. Waxes include those that dissolve in the ink composition and those that disperse as an emulsion or in any other form of fine particles. With such a wax in the ink, the resulting record tends to be better in abrasion resistance. Of particular note is that wax tends to contribute to improving abrasion resistance by concentrating on the surface of the ink coating on the recording medium, or at the interface between the air and the ink coating.

Such a wax can be of any kind, but examples include ester waxes formed by a higher fatty acid and a higher monohydric or dihydric alcohol, paraffin waxes, microcrystalline waxes, and olefin waxes as well as mixtures thereof.

Examples of polyolefin waxes include those produced from olefins, such as ethylene, propylene, and butylene, or their derivatives and copolymers thereof, specifically polyethylene waxes and polybutylene waxes. Commercially available polyolefin waxes can be used. Specific examples of waxes that can be used include NOPCOTE PEM17 (trade name, San Nopco Ltd.), CHEMIPEARL W4005 (trade name, Mitsui Chemicals, Inc.), AQUACER 515 and AQUACER 593 (trade names, BYK Japan KK), and Hytec E-6500 (Toho Chemical Industry, a polyethylene wax).

Preferably, the concentration of the wax, when contained, is 0.1% by mass or more and 5% by mass or less, more preferably 0.2% by mass or more and 4% by mass or less, even more preferably 0.3% by mass or more and 3% by mass or less of the total mass of the ink composition. A wax content in any of these ranges is preferred because it helps improve abrasion resistance. In that case, furthermore, the ink tends to be superior in ejection stability and recovery from clogging because its viscosity is kept low.

### Defoamer

The ink jet ink composition as a component of the ink set according to this embodiment may contain a defoamer. The defoamer can be of any kind, but examples include silicone defoamers, polyether defoamers, fatty acid ester defoamers, and acetylene glycol defoamers. Examples of commercially available defoamers include BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, and BYK-1770 (trade names, BYK Japan KK), Surfynol DF37, DF110D, DF58, DF75, DF220, and MD-20, and EnviroGem AD01 (all are trade names; Nissin Chemical Industry). One defoamer may be used alone, or two or more may be used as a mixture.

Preferably, the concentration of the defoamer(s), when contained, is 0.03% by mass or more and 0.7% by mass or less, more preferably 0.05% by mass or more and 0.5% by mass or less, even more preferably 0.08% by mass or more and 0.3% by mass or less of the total mass of the ink composition.

### Surfactant

Preferably, the ink jet ink composition as a component of the ink set according to this embodiment contains a surfactant. The surfactant can be of any kind, but examples include acetylene glycol surfactants, fluorosurfactants, and silicone surfactants.

For acetylene glycol surfactants, any of them can be used, but examples include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all are trade names; Air Products Japan, K.K.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all are trade names; Nissin Chemical Industry Co., Ltd.), ACETYLENOL E00, E00P, E40, and E100 (all are trade names; Kawaken Fine Chemicals Co., Ltd.).

For fluorosurfactants, it is preferred to use a fluorine-modified polymer. A specific example is BYK-340 (trade name, BYK Japan KK).

As for silicone surfactants, any of them can be used, but an example of a preferred one is a polysiloxane compound. The polysiloxane compound can be of any kind, but an example is a polyether-modified organosiloxane. Examples of commercially available polyether-modified organosiloxanes include BYK-306, BYK-307, BYK-333, BYK-341, BYK-345, BYK-346, and BYK-348 (trade names, BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, Shin-Etsu Chemical Co., Ltd.), and SILFACE SAG503A and SILFACE SAG014 (trade names, Nissin Chemical Industry Co., Ltd.).

One such surfactant may be used alone, or two or more may be used in combination.

When surfactant(s) is contained, it is preferred that the surfactant content is 0.1% by mass or more and 1.5% by mass or less of the total mass of the ink composition.

Preferably, the ink jet ink composition as a component of the ink set according to this embodiment contains such surfactant(s) at a concentration of 0.1% to 1.5% by mass of the total mass of the ink composition. Preferably, the percentage is 1.3% by mass or less, more preferably 1.1% by mass or less, even more preferably 0.9% by mass or less, in particular 0.7% by mass or less. Preferably, the percentage is 0.15% by mass or more, more preferably 0.25% by mass or more, even more preferably 0.3% by mass or more, in particular 0.35% by mass or more, especially 0.4% by mass or more.

Of these types of surfactants, the concentration of silicone or fluorinated ones may be, preferably is, set in any of these ranges. Of these types of surfactants, furthermore, the concentration of silicone ones may be, preferably is, set in any of these ranges.

In general, ink compositions containing a silicone surfactant tend to be improved in image quality but are likely to be inferior in abrasion resistance and foam breaking. The ink jet ink composition as a component of the ink set according to this embodiment, however, is superior in image quality even when the silicone content is as small as in the above ranges, and performs well in abrasion resistance and foam breaking, too.

### Other Additives

The ink jet ink composition as a component of the ink set according to this embodiment may optionally contain additives, such as a chelating agent, antirust, antimold, antioxidant, antireductant, and/or drying agent.

### 1.2.6. Preparation of the Ink Composition

The ink jet ink composition as a component of the ink set according to this embodiment is obtained by mixing the above ingredients in any order. Impurities may optionally be removed, for example by filtration. For the mixing of the ingredients, a suitable method is to add the materials one by one to a container equipped with a stirring device, such as a mechanical or magnetic stirrer, and mixing the materials together by stirring. The filtration can be done by performing centrifugal filtration, passing it through filter, etc., as necessary.

Preferably, the ink jet ink composition as a component of the ink set according to this embodiment has a surface tension (static surface tension) at 20° C. of 18 mN/m or more and 40 mN/m or less for the balance between the quality of images and the reliability of the composition for use as ink for ink jet recording. It is more preferred that the surface tension at 20° C. be 20 mN/m or more and 35 mN/m or less, even more preferably 22 mN/m or more and 33 mN/m or less. The surface tension can be measured by, for example, checking the surface tension the ink has when it wets a platinum plate under 20° C. conditions using CBVP-Z automated surface tensiometer (trade name, Kyowa Interface Science Co., Ltd.).

Likewise, it is preferred that the viscosity at 20° C. of the ink be 3 mPas or more and 10 mPas or less, more preferably 3 mPas or more and 8 mPas or less. The viscosity can be measured by, for example, measuring it under 20° C. conditions using MCR-300 rheometer (trade name, Physica).

### 1.3. Treatment Liquid

Another component of the ink set according to this embodiment, the treatment liquid is one that contains a flocculant. The following describes each ingredient in the treatment liquid.

### 1.3.1. Flocculant

The treatment liquid as a component of the ink set according to this embodiment contains a flocculant for ingredients in the ink composition. The flocculant contained in the treatment liquid reacts quickly with the colorant and resin, for example, in the ink composition during an ink attachment step, which will be described later herein. The reaction disrupts the dispersion of the colorant and resin in the ink composition, causing them to flocculate, and the resulting flocculates prevent the colorant from penetrating into the recording medium. As a result, the inventors believe, the ink is superior in improving the quality of the image recorded therewith.

Examples of flocculants include polyvalent metal salts, cationic resins, cationic surfactants, and other cationic compounds, and organic acids. One such flocculant may be used alone, or two or more may be used in combination. Of these flocculants, it is particularly preferred to use at least one selected from the group consisting of polyvalent metal salts, organic acids, and cationic resins because they are highly reactive with ingredients in the ink composition.

A polyvalent metal salt is formed by a polyvalent metal ion, having a valency of two or more, and an anion binding with the metal ion and is a water-soluble compound. Specific examples of polyvalent metal ions include divalent metal ions, such as Ca²⁺, Cu²⁺, Ni²⁺, Mg²⁺, Zn²⁺, and Ba²⁺; and trivalent metal ions, such as Al³⁺, Fe³⁺, and Cr³⁺. Examples of anions include Cl⁻, I⁻, Br⁻, SO₄²⁻, ClO³⁻, NO³⁻, and HCOO⁻ as well as CH₃COO⁻. Of such polyvalent metal salts, calcium salts and magnesium salts are particularly preferred for the stability of the treatment liquid and in terms of their reactivity when used as flocculants.

Examples of suitable organic acids include poly(meth)acrylic acid, formic acid, acetic acid, propionic acid, glycolic acid, oxalic acid, malonic acid, malic acid, maleic acid, ascorbic acid, succinic acid, glutaric acid, fumaric acid, citric acid, tartaric acid, lactic acid, pyruvic acid, pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, and derivatives of these compounds as well as salts thereof. One organic acid may be used alone, or two or more may be used in combination. Salts of organic acids that are also polyvalent metal salts are included in polyvalent metal salts.

Examples of cationic resins include cationic urethane resins, cationic olefin resins, and cationic amine resins. A cationic amine resin can be any resin having an amino group, and examples of them include allylamine resins, polyamine resins, quaternary ammonium salt polymers, and polyamide resins. Examples of polyamine resins include those having an amino group in their polymer backbone. Examples of allylamine resins include those having a structure derived from an allyl group in their polymer backbone. Examples of quaternary ammonium salt polymers include those having a quaternary ammonium salt in their structure. Examples of polyamide resins include those having an amide group in their polymer backbone with pendant amino groups. Of cationic resins, cationic amine resins are particularly preferred because they are not only highly reactive but also readily available.

Preferably, the flocculant concentration in the treatment liquid is 0.5% by mass or more, more preferably 1% by mass or more, even more preferably 3% by mass or more of the total mass of the treatment liquid. Preferably, the flocculant concentration in the treatment liquid is 20% by mass or less, more preferably 15% by mass or less, even more preferably 10% by mass or less of the total mass of the treatment liquid.

### 1.3.2. Other Ingredients

Ingredients other than the flocculant that may be contained in the treatment liquid as a component of the ink set according to this embodiment include water, a water-soluble organic compound, an organic compound sparingly soluble in water, a defoamer, a surfactant, and other additives. The percentage to the treatment liquid and other details of these ingredients are not described; they are the same as described above in relation to the ink jet ink composition. As long as it contains a flocculant, the chemical makeup of the treatment liquid can be chosen independently of that of the ink composition, for example as to whether or not it contains the ingredients other than colorants the ink composition may contain and the percentages and characteristics of the ingredients. The colorant content of the treatment liquid is 0.2% by mass or less, preferably 0.1% by mass or less, more preferably 0.05% by mass or less. The lower limit is 0% by mass.

Preferably, the treatment liquid as a component of the ink set according to this embodiment contains an organic compound sparingly soluble in water as defined above that is a diol or glycol ether having a normal boiling point of 180° C. to 300° C., more preferably a diol having a normal boiling point of 180° C. to 300° C. When the treatment liquid contains such an organic compound sparingly soluble in water, the organic compound can help further reduce banding irregularities, and the treatment liquid can be better in abrasion resistance.

### 1.3.3. Preparation of the Treatment Liquid

The treatment liquid as a component of the ink set according to this embodiment can be produced by dispersing and mixing these ingredients by an appropriate method. Thoroughly stirring the ingredients and then filtering the mixture to remove coarse particles and insoluble matter, which both can cause clogging, will give the desired treatment liquid.

### 1.3.4. Characteristics of the Treatment Liquid

When the treatment liquid as a component of the ink set according to this embodiment is ejected from an ink jet head, it is preferred that its surface tension at 25° C. be 18 mN/m or more and 40 mN/m or less, more preferably 20 mN/m or more and 35 mN/m or less, even more preferably 22 mN/m or more and 33 mN/m or less. The surface tension can be measured by, for example, checking the surface tension the treatment liquid has when it wets a platinum plate under 25° C. conditions using CBVP-Z automated surface tensiometer (trade name, Kyowa Interface Science Co., Ltd.).

Likewise, it is preferred that the viscosity at 25° C. of the treatment liquid be 3 mPas or more and 10 mPas or less, more preferably 3 mPas or more and 8 mPas or less. The viscosity can be measured by, for example, measuring it under 25° C. conditions using MCR-300 rheometer (trade name, Physica).

### 2. Recording Method

A recording method according to an embodiment of an aspect of the present disclosure is one in which recording is performed using the above ink set. The method includes an ink attachment step, in which the ink jet ink composition is ejected by ink jet technology and attached to a recording medium; and a treatment liquid attachment step, in which the treatment liquid is attached to the recording medium. The recording medium is a low- or non-absorbent recording medium.

The ink set used in the recording method according to this embodiment is one that includes an ink jet ink composition containing a particular organic compound sparingly soluble in water at a concentration equal to or smaller than a particular limit. By virtue of this, the recording method according to this embodiment combines great reduction of banding irregularities with superior storage stability of ink, despite involving a treatment liquid and being for recording on a low- or non-absorbent recording medium.

The following describes the recording method according to this embodiment in detail. An ink jet recording apparatus suitable for use in implementing this recording method will be described later herein.

### 2.1. Ink Attachment Step

The ink attachment step in the recording method according to this embodiment includes ejecting the ink jet ink composition as a component of the above ink set by ink jet technology and attaching it to a low- or non-absorbent recording medium.

The low- or non-absorbent recording medium is not described; it is as described above.

Preferably, in the ink attachment step, the ink composition loading per unit area of the recording medium in the region of the recording medium to which the ink is attached is 3 mg/inch² or more. It is more preferred that the ink composition loading be 5 mg/inch² or more, even more preferably 10 mg/inch² or more. Preferably, the ink composition loading per unit area of the recording medium is 20 mg/inch² or less, more preferably 18 mg/inch² or less, even more preferably 16 mg/inch² or less. When the ink composition loading is in any of these ranges, banding irregularities tend to be further reduced. Alternatively, in the region of the recording medium to which the ink is attached, the ink composition loading per unit area of the recording medium in the area in which the ink loading peaks, or the maximum ink loading, may be, preferably is, in any of these ranges.

### 2.2. Treatment Liquid Attachment Step

The treatment liquid attachment step in the recording method according to this embodiment includes attaching the treatment liquid as a component of the above ink set to the low- or non-absorbent recording medium.

The treatment liquid attachment step can be performed at the same time as the ink attachment step or before or after the ink attachment step.

Examples of methods for attaching the treatment liquid include dip coating, in which the recording medium is dipped into the treatment liquid; roller coating, in which the treatment liquid is attached using an instrument such as a brush, roller, spatula, or roll coater; spray coating, in which the treatment liquid is forced out of a spray or similar device; and ink jet coating, in which the treatment liquid is attached by ink jet technology. Of these, ink jet coating is particularly preferred.

Preferably, in the treatment liquid attachment step, the treatment liquid loading in the region of the recording medium in which the treatment liquid covers the ink or vice versa is 5% by mass or more of the ink composition loading in the ink attachment step. It is more preferred that the percentage of the treatment liquid loading be 7% by mass or more, in particular 9% by mass or more. At the same time, it is preferred that the treatment liquid loading be 25% by mass or less, more preferably 21% by mass or less, even more preferably 17% by mass or less, in particular 13% by mass or less of the ink composition loading in the ink attachment step. When the treatment liquid loading is in any of these ranges, the recording method tends to combine image qualities, such as banding irregularities and nonuniform flocculation, and abrasion resistance advantageously.

Preferably, the treatment liquid loading in the region of the recording medium in which the treatment liquid covers the ink or vice versa is from 0.1 to 5 mg/inch².

Alternatively, in the region of the recording medium in which the treatment liquid covers the ink or vice versa, the treatment liquid loading in the area in which the ink loading peaks may be, preferably is, in any of these ranges.

### 2.3. Serial Recording

Preferably, the recording method according to this embodiment is configured such that the recording involves multiple main scans and that multiple main scans are made in the same scan area. In other words, it is preferred that the above ink attachment and treatment liquid attachment steps be carried out as serial recording.

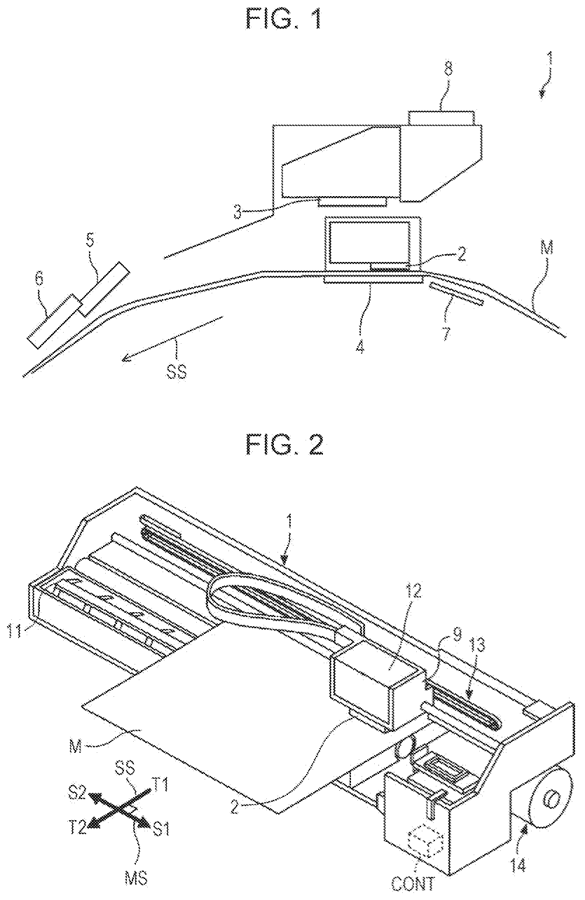

For example, the ink attachment and treatment liquid attachment steps can be carried out as serial recording by using an ink jet recording apparatus having a serial recording head (recording head 2) like that illustrated in FIGS. 1 and 2, which will be described later herein. In such a serial recording process, the ink attachment and treatment attachment steps involve multiple main scans, in which the ink composition and treatment liquid are attached to the same scan area of the recording medium M while the relative positions of the recording head 2 and recording medium M are changed in a main scanning direction MS, and multiple sub-scans, in which the relative positions of a carriage 9 and the recording medium M are changed in a sub-scanning direction SS, which crosses the main scanning direction MS. Preferably, the number of main scans is from 2 to 20, more preferably from 3 to 15, even more preferably from 4 to 10.

In that case, it is preferred that the recording head 2 have on its nozzle side (not illustrated) multiple rows of nozzles arranged in the main scanning direction MS, each of which is formed by multiple nozzles arranged in the sub-scanning direction SS. The rows of nozzles are arranged so that they will overlap or coincide when projected in the main scanning direction MS, and each row of nozzles ejects the treatment liquid or ink composition. This ensures the treatment liquid and ink composition will be ejected and attached to the same place in the sub-scanning direction of the recording medium in each single main scan.

When the recording method according to this embodiment is configured such that the recording involves multiple main scans and that multiple main scans are made in the same scan area, the quantity of ink droplets attached per main scan is small. In such a case, the ink droplets are attached discretely to the recording medium, which means there is little chance that adjacent ink droplets will come into contact with each other. In that case the ink does not fill space on the recording medium well, and the recorded image will more often have banding irregularities, or band-shaped irregularities thereon. Serial recording, therefore, is disadvantageous in that it more often suffers banding irregularities. The recording method according to this embodiment, which uses an ink set including an ink jet ink composition containing a particular organic compound sparingly soluble in water at a concentration equal to or smaller than a particular limit, reduces banding irregularities well and at the same time is superior in storage stability of ink even in such a serial recording process.

It should be noted that the statement multiple main scans are made in the same scan area means an area that has already scanned is scanned again. For example, when the distance of one sub-scan is smaller than the length of the ink-ejecting rows of nozzles in the sub-scanning direction, areas that are scanned in one main scan will be scanned again. For example, when the distance of one sub-scan is one fourth of the length of the ink-ejecting rows of nozzles in the sub-scanning direction, four main scans will be made in the same scan area. This case is described as the number of main scans being four.

Alternatively, the recording method according to this embodiment may be a line recording process, in which the recording is performed in one scan using a line head. In that case, too, band-shaped irregularities can occur in the direction of scanning, and this embodiment helps reduce the band-shaped irregularities.

### 2.4 First Heating Step

Preferably, the recording method according to this embodiment includes a first heating step, in which the ink jet ink composition attached to the recording medium is heated.

Including a first heating step in the recording method is advantageous in that it helps dry the ink composition and treatment liquid on the recording medium particularly fast, thereby helping achieve good image quality (nonuniform flocculation). The first heating step, in which the ink, etc., are dried quickly, prevents the ink from spreading smoothly on the recording medium on the other hand. A recording method including a first heating step, therefore, is disadvantageous in that it more often suffers banding irregularities. The recording method according to this embodiment, however, tends to help reduce banding irregularities well even in such a case.

The first heating step is drying freshly attached ink on the recording medium by heating it. The first heating step is a heating step for drying the ink attached to the recording medium, or at least part of its solvent component, at least to an extent that the flow of the ink will be reduced. The first heating step may be arranged so that the ink will be attached to a heated recording medium or may be arranged so that the ink will be heated soon after it is attached. Preferably, the heating in the first heating step is started not later than 0.5 seconds after the ink droplets land on the recording medium. The first heating step, furthermore, may involve attached treatment liquid in the same way as the ink.

Preferably, the first heating step is by heating with an IR heater, microwave radiation, heating with a platen heater, or sending warm air to the recording medium with a fan.

The heating in the first heating step only needs to be performed at one of the following time points: before the ink attachment and treatment liquid attachment steps, at the same time as the attachment, and soon after the attachment. The heating may be done at two or more of these time points, and preferably is at the same time as the attachment. The ink attachment and treatment liquid attachment steps can be carried out with the heating scheduled for such point(s) in the recording method.

When the ink is attached to a heated recording medium, the heating temperature in the first heating step is the surface temperature of the recording medium when the ink is attached thereto. When the ink is heated soon after it is attached, the heating temperature is the surface temperature of the recording medium to which it is heated, or the highest temperature of heating by the first heating step reached during the heating.

Preferably, the temperature of heating by the first heating step is 28° C. or above, more preferably 30° C. or above, even more preferably 32° C. or above, in particular 34° C. or above in terms of the surface temperature of the recording side of the heated recording medium. Preferably, the temperature of heating by the first heating step is 50° C. or below, more preferably 45° C. or below, even more preferably 40° C. or below in terms of the surface temperature of the recording side of the heated recording medium. When the temperature of heating by the first heating step is in any of these ranges, banding irregularities tend to be reduced well. It also tends to help achieve good image quality (nonuniform flocculation) and good recovery from clogging.

### 2.5. Postheating Step

Preferably, the recording method according to this embodiment includes a postheating step, in which the recording medium is heated, after the ink attachment and treatment liquid attachment steps described above.

In the recording method according to this embodiment, the ink jet ink composition as a component of the ink set used contains an organic compound sparingly soluble in water. After the ink attachment step, therefore, the ink dries well compared with when it does not contain an organic compound sparingly soluble in water. Including a postheating step in the recording method according to this embodiment is advantageous as it tends to further improve drying, thereby helping make the resulting record better in abrasion resistance.

The postheating step is a heating step in which the recording is finished and the record is heated sufficiently, to an extent that it will be ready for use. The postheating step is a heating step for sufficient drying of the solvent component of the ink and treatment liquid and for flattening the ink coating by heating resin, for example, contained in the ink. Preferably, the postheating step is started more than 0.5 seconds after the ink and the treatment liquid are attached to the recording medium. For example, it is preferred that a given recording region on the recording medium start being heated more than 0.5 seconds after the ink and treatment liquid assigned thereto is completely attached. Preferably, temperatures preferred in the first heating step and those in the postheating step are different.

The heating of the recording medium in the postheating step can be performed using an appropriate heater, for example when an ink jet recording apparatus is used. The heater does not need to be one the ink jet recording apparatus has; it can be any appropriate heater. In that case, it is preferred that the surface temperature of the recording medium be 60° C. or above, more preferably 70° C. or above, even more preferably 80° C. or above, in particular 85° C. or above. Preferably, the surface temperature of the recording medium heated in the postheating step is 120° C. or below, more preferably 110° C. or below, even more preferably 100° C. or below, in particular 95° C. or below. In the recording method according to this embodiment, the ink tends to dry sufficiently, and the resulting record tends to be superior in abrasion resistance, even when the surface temperature of the recording medium is in any of these ranges.

### 2.6. Ink Jet Recording Apparatus

The following describes an example of an ink jet recording apparatus suitable for use in implementing the recording method according to this embodiment with reference to drawings.

### Apparatus Structure Outline

FIG. 1 is an outline cross-sectional diagram schematically illustrating the ink jet recording apparatus. FIG. 2 is a perspective view of the carriage and related components of the ink jet recording apparatus 1 in FIG. 1, illustrating them in an exemplary configuration. As illustrated in FIGS. 1 and 2, the ink jet recording apparatus 1 includes a recording head 2, an IR heater 3, a platen heater 4, a heating heater 5, a cooling fan 6, a preheater 7, an aeration fan 8, a carriage 9, a platen 11, a carriage-moving mechanism 13, a transporter 14, and a control section CONT. The ink jet recording apparatus 1 is such that its overall operation is controlled by the control section CONT, illustrated in FIG. 2.

### Structure of the Recording Head and Related Components

The recording head 2 is configured to perform recording on a recording medium M by ejecting the ink jet ink composition through its nozzles and attaching it. For the treatment liquid, too, the recording head 2 can be configured in the same way. The recording head 2 illustrated in FIGS. 1 and 2 is a serial recording head; it attaches the ink and the treatment liquid to the recording medium M by running relative to the recording medium M in a main scanning direction multiple times. The recording head 2 is placed on the carriage 9, illustrated in FIG. 2. As the carriage-moving mechanism 13 operates to move the carriage 9 in the direction of medium width or along the width of the recording medium M, the recording head 2 is caused to run relative to the recording medium M in the main scanning direction multiple times. The direction of medium width is the main scanning direction, in which the recording head 2 scans. An act of running in the main scanning direction is also referred to as a main scan.

The main scanning direction is also the direction in which the carriage 9 moves with the recording head 2 thereon. In FIG. 1, it is a direction that crosses a sub-scanning direction, indicated by arrow SS, which is the direction of transport of the recording medium M. In FIG. 2, the direction along the width of the recording medium M, i.e., direction S1-S2, is the main scanning direction MS, and the direction of T1→T2 is the sub-scanning direction SS. It should be noted that the recording head 2 runs in the main scanning direction, i.e., in one of the direction of arrow S1 or that of arrow S2, in the time frame of one scan, and a main scan, made by the recording head 2, and a sub-scan, which is the transport of the recording medium M, are repeated to perform recording on the recording medium M.

A cartridge assembly 12, which supplies the ink and the treatment liquid to the recording head 2, includes multiple independent cartridges. The cartridge assembly 12 is detachably attached to the carriage 9 carrying the recording head 2 thereon. Each of the multiple cartridges can hold a different kind of ink jet ink composition or treatment liquid, and the ink jet ink composition and the treatment liquid are supplied from the cartridge assembly 12 to each nozzle. Although the cartridge assembly 12 in the example illustrated in FIGS. 1 and 2 is placed on the carriage 9, this is not the only possible configuration; it may be provided somewhere other than the carriage 9, and the ink and treatment liquid may be supplied to each nozzle through feed tubing not illustrated.

The mode of ejection from the recording head 2 can be a known one. The illustrated example employs the mode in which vibrations of piezoelectric elements are used to eject droplets, i.e., the ejection mode in which ink droplets, for example, are formed by mechanical deformation of electrostrictive elements.

### First Heating Mechanism

The ink jet recording apparatus 1 may include a first heating mechanism, a mechanism that heats the recording medium M when the ink and the treatment liquid are ejected from the recording head 2 and attached to the recording medium. The first heating mechanism can be, for example, a conduction, air-blow, or radiation heating mechanism. A conduction heating mechanism delivers heat to the recording medium through its component touching the recording medium. An example is a platen heater. An air-blow heating mechanism dries the ink, etc., by sending ambient or warm air to the recording medium M. An example is an aeration fan. A radiation heating mechanism heats the recording medium by emitting thermal radiation to the recording medium. An example is IR radiation. Although not illustrated, there may be a heater similar to a platen heater immediately downstream of the platen heater 4 in the SS direction. One such first heating mechanism may be used alone, or more than one may be used in combination. For example, the ink jet recording apparatus 1 includes an IR heater 3 and a platen heater 4 as first heating mechanisms.

The IR heater 3 allows the recording medium M to be heated from the recording head 2 side by radiation heating, by irradiating the recording medium M with infrared radiation. This often causes the recording head 2, too, to be heated but helps elevate the temperature of the recording medium M with less influence of its thickness than with heating from the back of the recording medium M, for example using the platen heater 4. The ink jet recording apparatus 1 may include fans that dry the ink, etc., on the recording medium M by blowing warm air or air at the ambient temperature against the recording medium M (e.g., an aeration fan 8).

The platen heater 4 is configured to heat the recording medium M at a position where it faces the recording head 2, mediated by the platen 11. Configured to heat the recording medium M by condition heating, the platen heater 4 is optional in the ink jet recording method.

The ink jet recording apparatus 1, furthermore, may include a preheater 7 that heats the recording medium M preliminarily, before the ink and the treatment liquid are attached to the recording medium M.

### Postheating Mechanism

The ink jet recording apparatus 1 may include a postheating mechanism, a mechanism that heats the recording medium after the ink attachment and treatment liquid attachment steps to dry and fix the ink, etc.

The heating heater 5, for use as a postheating mechanism, is one that dries and solidifies the ink, etc., attached to the recording medium M. By heating the recording medium M with a recorded image thereon, the heating heater 5 accelerates the evaporation and release of water, for example, in the ink and the treatment liquid. This allows resin in the ink to form an ink film, and this ink film is firmly fixed on or adheres strongly to the recording medium M. Enabling good film formation in such a way, the postheating mechanism allows the ink jet recording apparatus 1 to produce a good and high-quality image in a short time.

### Other Components

The ink jet recording apparatus 1 may have a cooling fan 6. By drying the ink, etc., recorded on the recording medium M and then cooling the ink on the recording medium M with the cooling fan 6, a highly adhesive ink coating can be formed on the recording medium M.

Under the carriage 9 are a platen 11 that supports the recording medium M, a carriage-moving mechanism 13 that moves the carriage 9 relative to the recording medium M, and a transporter 14 that is a roller that transports the recording medium M in the sub-scanning direction. The operation of the carriage-moving mechanism 13 and the transporter 14 is controlled by the control section CONT.

### Electrical Control

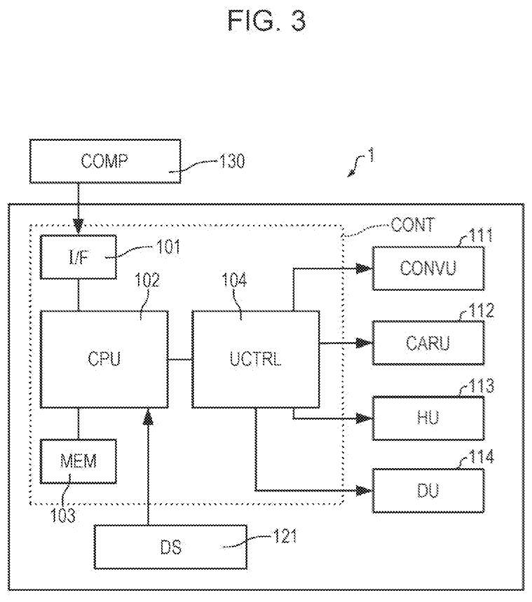

FIG. 3 is a functional block diagram for the ink jet recording apparatus 1. The control section CONT is a control unit for controlling the ink jet recording apparatus 1. The interface 101 (I/F) is for exchanging data between a computer 130 (COMP) and the ink jet recording apparatus 1. The CPU 102 is a processing unit for overall control of the ink jet recording apparatus 1. The memory 103 (MEM) is for, for example, storing programs and providing workspace for the CPU 102. The CPU 102 controls each unit via a unit control circuit 104 (UCTRL). A set of detectors 121 (DS) monitor the internal status of the ink jet recording apparatus 1. Based on the detection results, the control section CONT controls each unit.

The transport unit 111 (CONVU) is one that controls sub-scans (transport) during ink jet recording. Specifically, it controls the direction and rate of transport of the recording medium M. To be more specific, the transport unit 111 controls the direction and rate of transport of the recording medium M by controlling the direction and rate of rotation of a motor-driven transport roller.

The carriage unit 112 (CARU) is one that controls main scans (passes) during ink jet recording. Specifically, it is a unit that moves the recording head 2 back and forth in the main scanning direction. The carriage unit 112 includes a carriage 9 with the recording head 2 thereon and a carriage-moving mechanism 13 for moving the carriage 9 back and forth.

The head unit 113 (HU) is one that controls the volume of the ink and the treatment liquid ejected from the nozzles of the recording head 2. For example, when the nozzles of the recording head 2 are ones driven by piezoelectric elements, the head unit 113 controls the operation of the piezoelectric element in each nozzle. By the head unit 113, parameters are controlled such as the time when to attach each ink and the treatment liquid and the dot size for the ink and the treatment liquid. The carriage unit 112 and the head unit 113, furthermore, work together to control the volume of the ink and the treatment liquid attached per scan.

The drying unit 114 (DU) controls the temperature of heaters, such as the IR heater 3, preheater 7, platen heater 4, and heating heater 5.

This ink jet recording apparatus 1 alternates the operation of moving the carriage 9, with the recording head 2 thereon, in the main scanning direction and a transport operation (sub-scan). During this, the control section CONT controls the carriage unit 112 in each pass to move the recording head 2 in the main scanning direction. At the same time, the head unit 113 is controlled to eject droplets of the ink and the treatment liquid from predetermined nozzle orifices of the recording head 2 and attach the droplets of the ink and the treatment liquid to the recording medium M. The control section CONT, furthermore, controls the transport unit 111 to transport the recording medium M in the direction of transport by a predetermined distance (feed) during the transport operation.

As the ink jet recording apparatus 1 repeats a main scan (pass) and a sub-scan (transport operation), a recording region is transported little by little with multiple attached droplets thereon. Then the heating heater 5 is used to dry the droplets attached to the recording medium M, finishing an image. The finished record may then be wound into a roll by a reel mechanism or transported on a flatbed mechanism.

### 3. Examples

The following describes aspects of the present disclosure in further detail by providing examples, but no aspect of the present disclosure is not limited to these examples. In the following “%” is by mass unless stated otherwise.

### 3.1. Preparation of Ink Jet Ink Compositions

Ink jet ink compositions A to Y (inks A to Y) according to examples and comparative examples were obtained by putting ingredients into a container according to the formula in Table 1 or 2 below, mixing them together and stirring for 2 hours using a magnetic stirrer, and then filtering the product through a 5-μm membrane filter. In the tables, the value for the pigment, resin, and wax represents their percentage on a solids basis. The pigment was used in the form of a liquid dispersion as described below.

### Preparation of a Liquid Dispersion of Pigment

The liquid dispersion of pigment used was prepared beforehand as follows. First, 50 g of methyl ethyl ketone (MEK) was added to a flask equipped with a dropping funnel, a nitrogen inlet tube, a reflux condenser, a thermometer, and a stirrer and warmed to 75° C. while being bubbled with nitrogen. To the warmed ketone, a mixture of the monomers of 80 g of butyl methacrylate, 50 g of methyl methacrylate, 15 g of styrene, and 20 g of methacrylic acid, 50 g of MEK, and 500 mg of a polymerization initiator (azobisisobutyronitrile, AIBN) was added dropwise from the dropping funnel over 3 hours. After the addition, the mixture was heated under reflux for another 6 hours and allowed to cool, and then MEK was added to make up for the loss on evaporation, giving a resin solution (resin content on a solids basis, 50% by mass; acid value, 79 mg/KOH; Tg, 65° C.). To 20 g of this solution, a predetermined amount of a 20% by mass aqueous solution of sodium hydroxide as a neutralizing agent was added to neutralize 100% of salt-forming groups. To the neutralized solution 50 g of pigment (C.I. Pigment Blue 15:3) was added little by little with stirring, and the product was kneaded in a bead mill for 2 hours. The resulting paste was stirred with 200 g of deionized water and then warmed under reduced pressure to remove MEK by distillation. The concentration was adjusted with deionized water, giving a liquid dispersion of pigment (pigment content on a solids basis, 20% by mass; resin content on a solids basis, 5% by weight).

### 3.2. Preparation of Treatment Liquids

Treatment liquids A to H according to examples and comparative examples were obtained by putting ingredients into a container according to the formula in Table 3 below, mixing them together and stirring for 2 hours using a magnetic stirrer, and then filtering the product through a 5-μm membrane filter. In the table, the value for the cationic resin represents its percentage on a solids basis.

TABLE 1

| | | Ink A | Ink B | Ink C | Ink D | Ink E | Ink F | Ink G |
|---|---|---|---|---|---|---|---|---|
| Water-soluble | CPL (cyclic amide) | 8 | 8 | 8 | 8 | 8 | 8 | 8 |
| organic compounds | 2P (cyclic amide) | | | | | | | |
| (resin-dissolving | DMPA (linear amide) | | | | | | | |
| substances) | DMSO (sulfur-containing solvent) | | | | | | | |
| | EOXM (cyclic ether) | | | | | | | |
| Water-soluble | PG (solubility, ∞; boiling point, 188° C.) | 15 | 15 | 15 | 15 | 15 | 15 | 15 |
| organic compounds | DMHD (solubility, 14; boiling point, 218° C.) | | | | | | | |
| (others) | 1,2HD (solubility, ∞; boiling point, 224° C.) | 1 | 1 | 1 | 1 | 1 | 1 | 1 |
| | TIPA (solubility, 83; boiling point, 301° C.) | 0.1 | 0.1 | 0.1 | 0.1 | 0.1 | 0.1 | 0.1 |
| Organic compounds | BEPD (solubility, 0.9; boiling point, 264° C.) | 0.5 | 1 | 0.2 | | 2.5 | | |
| sparingly soluble | CHDM (solubility, 0.8; boiling point, 286° C.) | | | | | | 0.5 | |
| in water (diols) | TMPD (solubility, 1.9; boiling point, 232° C.) | | | | | | | 0.5 |
| | EHD (solubility, 4.2; boiling point, 244° C.) | | | | | | | |
| | TMCD (solubility, 6.1; boiling point, 220° C.) | | | | | | | |
| | MPPD (solubility, 7.5; boiling point, 230° C.) | | | | | | | |
| | EHGL (solubility, 0.2; boiling point, 325° C.) | | | | | | | |
| Organic compounds | EHDG (solubility, 0.5; boiling point, 277° C.) | | | | | | | |
| sparingly soluble | DBDG (solubility, 0.3; boiling point, 256° C.) | | | | | | | |
| in water (glycol | EHG (solubility, 0.1; boiling point, 229° C.) | | | | | | | |
| ethers) | | | | | | | | |
| Organic compounds | NOP (solubility, 0.1) | | | | | | | |
| sparingly soluble | | | | | | | | |
| in water (others) | | | | | | | | |
| Pigment | Liquid dispersion of cyan pigment (active | 4 | 4 | 4 | 4 | 4 | 4 | 4 |
| | ingredient) | | | | | | | |
| Resin | Joncryl 631 (active ingredient) | 6 | 6 | 6 | 6 | 6 | 6 | 6 |
| Wax | Hytec E-6500 (active ingredient) | 0.5 | 0.5 | 0.5 | 0.5 | 0.5 | 0.5 | 0.5 |
| Defoamer | Surfynol DF110D | 0.2 | 0.2 | 0.2 | 0.2 | 0.2 | 0.2 | 0.2 |
| Surfactant | BYK333 | 0.5 | 0.5 | 0.5 | 0.5 | 0.5 | 0.5 | 0.5 |
| Purified water | — | Balance | Balance | Balance | Balance | Balance | Balance | Balance |

| | | | | | | | |
|---|---|---|---|---|---|---|---|
| Total | 100 | 100 | 100 | 100 | 100 | 100 | 100 |
| Storage stability | AA | A | AA | AA | C | AA | AA |
| Foam breaking | A | A | A | A | A | A | A |

| | | Ink H | Ink I | Ink J | Ink K | Ink L | Ink M |
|---|---|---|---|---|---|---|---|
| Water-soluble | CPL (cyclic amide) | 8 | 8 | 8 | 8 | 8 | 8 |
| organic compounds | 2P (cyclic amide) | | | | | | |
| (resin-dissolving | DMPA (linear amide) | | | | | | |
| substances) | DMSO (sulfur-containing solvent) | | | | | | |
| | EOXM (cyclic ether) | | | | | | |
| Water-soluble | PG (solubility, ∞; boiling point, 188° C.) | 15 | 15 | 15 | 15 | 15 | 15 |
| organic compounds | DMHD (solubility, 14; boiling point, 218° C.) | | | | | | |
| (others) | 1,2HD (solubility, ∞; boiling point, 224° C.) | 1 | 1 | 1 | 1 | 1 | 1 |
| | TIPA (solubility, 83; boiling point, 301° C.) | 0.1 | 0.1 | 0.1 | 0.1 | 0.1 | 0.1 |
| Organic compounds | BEPD (solubility, 0.9; boiling point, 264° C.) | | | | | | |
| sparingly soluble | CHDM (solubility, 0.8; boiling point, 286° C.) | | | | | | |
| in water (diols) | TMPD (solubility, 1.9; boiling point, 232° C.) | | | | | | |
| | EHD (solubility, 4.2; boiling point, 244° C.) | 0.5 | | | | | |
| | TMCD (solubility, 6.1; boiling point, 220° C.) | | 0.5 | | | | |
| | MPPD (solubility, 7.5; boiling point, 230° C.) | | | 0.5 | | | |
| | EHGL (solubility, 0.2; boiling point, 325° C.) | | | | | | |
| Organic compounds | EHDG (solubility, 0.5; boiling point, 277° C.) | | | | 0.5 | | |
| sparingly soluble | DBDG (solubility, 0.3; boiling point, 256° C.) | | | | | 0.5 | |
| in water (glycol | EHG (solubility, 0.1; boiling point, 229° C.) | | | | | | 0.5 |
| ethers) | | | | | | | |
| Organic compounds | NOP (solubility, 0.1) | | | | | | |
| sparingly soluble | | | | | | | |
| in water (others) | | | | | | | |
| Pigment | Liquid dispersion of cyan pigment (active | 4 | 4 | 4 | 4 | 4 | 4 |
| | ingredient) | | | | | | |
| Resin | Joncryl 631 (active ingredient) | 6 | 6 | 6 | 6 | 6 | 6 |
| Wax | Hytec E-6500 (active ingredient) | 0.5 | 0.5 | 0.5 | 0.5 | 0.5 | 0.5 |
| Defoamer | Surfynol DF110D | 0.2 | 0.2 | 0.2 | 0.2 | 0.2 | 0.2 |
| Surfactant | BYK333 | 0.5 | 0.5 | 0.5 | 0.5 | 0.5 | 0.5 |
| Purified water | — | Balance | Balance | Balance | Balance | Balance | Balance |

| | | | | | | |
|---|---|---|---|---|---|---|
| Total | 100 | 100 | 100 | 100 | 100 | 100 |
| Storage stability | AA | AA | AA | A | B | B |
| Foam breaking | A | A | A | A | A | A |

TABLE 2

| | | Ink N | Ink O | Ink P | Ink Q | Ink R | Ink S |
|---|---|---|---|---|---|---|---|
| Water-soluble | CPL (cyclic amide) | 8 | 4 | | | | |
| organic compounds | 2P (cyclic amide) | | | | 8 | | |
| (resin-dissolving | DMPA (linear amide) | | | | | 8 | |
| substances) | DMSO (sulfur-containing solvent) | | | | | | 8 |
| | EOXM (cyclic ether) | | | | | | |
| Water-soluble | PG (solubility, ∞; boiling point, 188° C.) | 15 | 15 | 15 | 15 | 15 | 15 |
| organic compounds | DMHD (solubility, 14; boiling point, 218° C.) | | | | | | |
| (others) | 1,2HD (solubility, ∞; boiling point, 224° C.) | 1 | 1 | 1 | 1 | 1 | 1 |
| | TIPA (solubility, 83; boiling point, 301° C.) | 0.1 | 0.1 | 0.1 | 0.1 | 0.1 | 0.1 |
| Organic compounds | BEPD (solubility, 0.9; boiling point, 264° C.) | | 0.5 | 0.5 | 0.5 | 0.5 | 0.5 |
| sparingly soluble | CHDM (solubility, 0.8; boiling point, 286° C.) | | | | | | |
| in water (diols) | TMPD (solubility, 1.9; boiling point, 232° C.) | | | | | | |
| | EHD (solubility, 4.2; boiling point, 244° C.) | | | | | | |
| | TMCD (solubility, 6.1; boiling point, 220° C.) | | | | | | |
| | MPPD (solubility, 7.5; boiling point, 230° C.) | | | | | | |
| | EHGL (solubility, 0.2; boiling point, 325° C.) | | | | | | |
| Organic compounds | EHDG (solubility, 0.5; boiling point, 277° C.) | | | | | | |
| sparingly soluble | DBDG (solubility, 0.3; boiling point, 256° C.) | | | | | | |
| in water (glycol | EHG (solubility, 0.1; boiling point, 229° C.) | | | | | | |
| ethers) | | | | | | | |
| Organic compounds | NOP (solubility, 0.1) | 0.5 | | | | | |
| sparingly soluble | | | | | | | |
| in water (others) | | | | | | | |
| Pigment | Liquid dispersion of cyan pigment (active | 4 | 4 | 4 | 4 | 4 | 4 |
| | ingredient) | | | | | | |
| Resin | Joncryl 631 (active ingredient) | 6 | 6 | 6 | 6 | 6 | 6 |
| Wax | Hytec E-6500 (active ingredient) | 0.5 | 0.5 | 0.5 | 0.5 | 0.5 | 0.5 |
| Defoamer | Surfynol DF110D | 0.2 | 0.2 | 0.2 | 0.2 | 0.2 | 0.2 |
| Surfactant | BYK333 | 0.5 | 0.5 | 0.5 | 0.5 | 0.5 | 0.5 |
| Purified water | — | Balance | Balance | Balance | Balance | Balance | Balance |
| Total | | 100 | 100 | 100 | 100 | 100 | 100 |
| Storage stability | | C | AA | A | AA | A | A |
| Foam breaking | | A | A | A | A | A | A |
| | | Ink T | Ink U | Ink V | Ink W | Ink X | Ink Y |
| Water-soluble | CPL (cyclic amide) | | 8 | 8 | | 8 | 8 |
| organic compounds | 2P (cyclic amide) | | | | 14 | | |
| (resin-dissolving | DMPA (linear amide) | | | | | | |
| substances) | DMSO (sulfur-containing solvent) | | | | | | |
| | EOXM (cyclic ether) | 8 | | | | | |
| Water-soluble | PG (solubility, ∞; boiling point, 188° C.) | 15 | 15 | 15 | 15 | | 15 |
| organic compounds | DMHD (solubility, 14; boiling point, 218° C.) | | | | | 15 | |
| (others) | 1,2HD (solubility, ∞; boiling point, 224° C.) | 1 | 1 | 1 | 1 | 1 | 1 |
| | TIPA (solubility, 83; boiling point, 301° C.) | 0.1 | 0.1 | 0.1 | 0.1 | 0.1 | 0.1 |
| Organic compounds | BEPD (solubility, 0.9; boiling point, 264° C.) | 0.5 | 0.5 | 0.5 | 0.5 | 0.5 | |
| sparingly soluble | CHDM (solubility, 0.8; boiling point, 286° C.) | | | | | | |
| in water (diols) | TMPD (solubility, 1.9; boiling point, 232° C.) | | | | | | |
| | EHD (solubility, 4.2; boiling point, 244° C.) | | | | | | |
| | TMCD (solubility, 6.1; boiling point, 220° C.) | | | | | | |
| | MPPD (solubility, 7.5; boiling point, 230° C.) | | | | | | |
| | EHGL (solubility, 0.2; boiling point, 325° C.) | | | | | | 0.5 |
| Organic compounds | EHDG (solubility, 0.5; boiling point, 277° C.) | | | | | | |
| sparingly soluble | DBDG (solubility, 0.3; boiling point, 256° C.) | | | | | | |
| in water (glycol | EHG (solubility, 0.1; boiling point, 229° C.) | | | | | | |
| ethers) | | | | | | | |
| Organic compounds | NOP (solubility, 0.1) | | | | | | |
| sparingly soluble | | | | | | | |
| in water (others) | | | | | | | |
| Pigment | Liquid dispersion of cyan pigment (active | 4 | 4 | 4 | 4 | 4 | 4 |
| | ingredient) | | | | | | |
| Resin | Joncryl 631 (active ingredient) | 6 | 6 | 6 | 6 | 6 | 6 |
| Wax | Hytec E-6500 (active ingredient) | 0.5 | 0.5 | 0.5 | 0.5 | 0.5 | 0.5 |
| Defoamer | Surfynol DF110D | 0.2 | 0.2 | 0.2 | 0.2 | 0.2 | 0.2 |
| Surfactant | BYK333 | 0.5 | 1 | 0.2 | 0.5 | 0.5 | 0.5 |
| Purified water | — | Balance | Balance | Balance | Balance | Balance | Balance |

| | | | | | | |
|---|---|---|---|---|---|---|
| Total | 100 | 100 | 100 | 100 | 100 | 100 |
| Storage stability | A | AA | AA | A | B | AA |
| Foam breaking | A | B | AA | A | A | A |

TABLE 3

| | | Treatment | Treatment | Treatment | Treatment | Treatment | Treatment | Treatment | Treatment |
|---|---|---|---|---|---|---|---|---|---|
| | | liquid A | liquid B | liquid C | liquid D | liquid E | liquid F | liquid G | liquid H |
| Water-soluble | CPL (cyclic amide) | 8 | 8 | 8 | | 8 | 8 | 8 | 8 |
| organic compounds | 2P (cyclic amide) | | | | 8 | | | | |
| (resin-dissolving | | | | | | | | | |
| substances) | | | | | | | | | |
| Water-soluble | PG | 15 | 15 | 15 | 15 | 15 | 15 | 15 | 15 |
| organic compounds | 1,2HD | 1 | 1 | 1 | 1 | 1 | 1 | 1 | 1 |
| (others) | | | | | | | | | |
| Organic compounds | BEPD | 0.5 | | | 0.5 | 0.5 | 0.5 | 0.5 | 0.5 |
| sparingly soluble | (solubility, 0.9) | | | | | | | | |
| in water (diols) | | | | | | | | | |
| Organic compounds | EHDG | | 0.5 | | | | | | |
| sparingly soluble | (solubility, 0.5) | | | | | | | | |
| in water (glycol | | | | | | | | | |
| ethers) | | | | | | | | | |
| Polyvalent metal | Calcium propionate | 8 | 8 | 8 | 8 | | | | 12 |
| salts | Magnesium sulfate | | | | | 8 | | | |
| | heptahydrate | | | | | | | | |
| Cationic resin | Catiomaster PD-30 | | | | | | 3 | | |
| | (active ingredient) | | | | | | | | |
| Organic acid | L-tartaric acid | 0.1 | 0.1 | 0.1 | 0.1 | 0.1 | 0.1 | 4 | 0.1 |
| Defoamer | Surfynol DF110D | 0.2 | 0.2 | 0.2 | 0.2 | 0.2 | 0.2 | 0.2 | 0.2 |
| Surfactant | BYK333 | 0.5 | 0.5 | 0.5 | 0.5 | 0.5 | 0.5 | 0.5 | 0.5 |
| Purified water | — | Balance | Balance | Balance | Balance | Balance | Balance | Balance | Balance |

| | | | | | | | | |
|---|---|---|---|---|---|---|---|---|
| Total | 100 | 100 | 100 | 100 | 100 | 100 | 100 | 100 |

The following is supplementary data on each ingredient in Tables 1 to 3 above.

### Water-Soluble Organic Compounds (Resin-Dissolving Substances)

CPL: ε-caprolactam; boiling point, 267° C.; melting point, 70° C.; solid (25° C.); a cyclic amide
2P: 2-pyrrolidone; boiling point, 245° C.; melting point, 25° C.; liquid (25° C.); a cyclic amide
DMPA: 3-methoxy-N,N-dimethylpropanamide; boiling point, 215° C.; melting point, −49° C.; liquid (25° C.); a linear amide
DMSO: dimethylsulfoxide; boiling point, 189° C.; melting point, 19° C.; liquid (25° C.); a sulfur-containing solvent
EOXM: 3-ethyl-3-oxetanemethanol; boiling point, 220° C.; melting point, −31° C.; liquid (25° C.); a cyclic ether Water-Soluble Organic Compounds (others)
PG: propylene glycol; boiling point, 188° C.; melting point, −59° C.; liquid (25° C.); an aliphatic diol; completely miscible with water
DMHD: 2,5-dimethyl-2,5-hexanediol; boiling point, 218° C.; melting point, 89° C.; solid (25° C.); an aliphatic diol; solubility, 14 [g/100 g of water]
1,2HD: 1,2-hexanediol; boiling point, 224° C.; melting point, 2° C.; liquid (25° C.); an aliphatic diol; completely miscible with water
TIPA: triisopropanolamine; boiling point, 301° C.; melting point, 45° C.; solid (25° C.); an amine; solubility, 83 [g/100 g of water]

### Organic Compounds Sparingly Soluble in Water (Diols)

BEPD: 2-butyl-2-ethyl-1,3-propanediol; boiling point, 264° C.; melting point, 43° C.; solid (25° C.); an aliphatic diol; solubility, 0.9 [g/100 g of water]
CHDM: 1,4-cyclohexanedimethanol; boiling point, 286° C.; melting point, 35° C.; solid (25° C.); an alicyclic diol; solubility, 0.8 [g/100 g of water]
TMPD: 2,2,4-trimethyl-1,3-pentanediol; boiling point, 232° C.; melting point, 54° C.; solid (25° C.); an aliphatic diol; solubility, 1.9 [g/100 g of water]
EHD: 2-ethyl-1,3-hexanediol; boiling point, 244° C.; melting point, −40° C.; liquid (25° C.); an aliphatic diol; solubility, 4.2 [g/100 g of water]
TMCD: 2,2,4,4-tetramethyl-1,3-cyclobutanediol; boiling point, 220° C.; melting point, 126° C.; solid (25° C.); an alicyclic diol; solubility, 6.1 [g/100 g of water]
MPPD: 2-methyl-2-propyl-1,3-propanediol; boiling point, 230° C.; melting point, 57° C.; solid (25° C.); an aliphatic diol; solubility, 7.5 [g/100 g of water]
EHGL: ethylhexyl glycerol; boiling point, 325° C.; melting point, −76° C.; liquid (25° C.); an aliphatic diol; solubility, 0.2 [g/100 g of water]

### Organic Compounds Sparingly Soluble in Water (Glycol Ethers)

EHDG: diethylene glycol mono-2-ethylhexyl ether; boiling point, 277° C.; melting point, −82° C.; liquid (25° C.); a glycol monoether; solubility, 0.5 [g/100 g of water]
DBDG: diethylene glycol dibutyl ether; boiling point, 256° C.; melting point, −60° C.; liquid (25° C.); a glycol ether; solubility, 0.3 [g/100 g of water]
EHG: ethylene glycol mono-2-ethylhexyl ether; boiling point, 229° C.; melting point, −105° C.; liquid (25° C.); a glycol monoether; solubility, 0.1 [g/100 g of water]

### Organic Compounds Sparingly Soluble in Water (Others)

NOP: N-octyl-2-pyrrolidone; boiling point, 306° C.; melting point, −23° C.; liquid (25° C.); a cyclic amide; solubility, 0.1 [g/100 g of water]

### Other Ingredients

### Resin

Joncryl 631: trade name of a BASF Japan product; a styrene-acrylic resin; Tg, 105° C.

### Wax

Hytec E-6500: trade name of a Toho Chemical Industry product, a polyethylene wax Defoamer
Surfynol DF110D: trade name of a Nissin Chemical Industry product, an acetylenediol surfactant Surfactant
BYK333: trade name of a BYK Japan product, a silicone surfactant Cationic Resin
Catiomaster PD-30: trade name of a Yokkaichi Chemical product, an amine-epichlorohydrin copolymer Organic Acid
L-tartaric acid: boiling point, 275° C.; melting point, 168° C.

TABLE 4

| | Example 1 | Example 2 | Example 3 | Example 4 | Example 5 | Example 6 | Example 7 |
|---|---|---|---|---|---|---|---|
| Ink | Ink A | Ink B | Ink C | Ink F | Ink G | Ink H | Ink I |
| Treatment liquid | Treatment | Treatment | Treatment | Treatment | Treatment | Treatment | Treatment |
| | liquid A | liquid A | liquid A | liquid A | liquid A | liquid A | liquid A |
| Treatment liquid loading | 10% | 10% | 10% | 10% | 10% | 10% | 10% |
| (% by mass, of ink) | | | | | | | |
| Attachment temperature | 35 | 35 | 35 | 35 | 35 | 35 | 35 |
| (° C.) | | | | | | | |
| Image quality (banding | A | AA | B | A | A | B | B |
| irregularities) | | | | | | | |
| Image quality (nonuniform | A | A | A | A | A | A | A |
| flocculation) | | | | | | | |
| Abrasion resistance | A | A | A | B | A | A | A |
| Recovery from clogging | A | B | A | A | A | A | A |
| [ink] | | | | | | | |
| Misalignment [treatment | A | A | A | A | A | A | A |
| liquid] | | | | | | | |
| Storage stability of the | AA | A | AA | AA | AA | AA | AA |
| ink used | | | | | | | |

| | Example 8 | Example 9 | Example 10 | Example 11 | Example 12 | Example 13 |
|---|---|---|---|---|---|---|
| Ink | Ink J | Ink K | Ink L | Ink M | Ink O | Ink P |
| Treatment liquid | Treatment | Treatment | Treatment | Treatment | Treatment | Treatment |
| | liquid A | liquid A | liquid A | liquid A | liquid A | liquid A |
| Treatment liquid loading | 10% | 10% | 10% | 10% | 10% | 10% |
| (% by mass, of ink) | | | | | | |
| Attachment temperature | 35 | 35 | 35 | 35 | 35 | 35 |
| (° C.) | | | | | | |
| Image quality (banding | B | A | AA | AA | A | A |
| irregularities) | | | | | | |
| Image quality (nonuniform | A | A | A | A | A | B |
| flocculation) | | | | | | |
| Abrasion resistance | A | B | A | A | B | C |
| Recovery from clogging | A | A | B | B | AA | AA |
| [ink] | | | | | | |
| Misalignment [treatment | A | A | A | A | A | A |
| liquid] | | | | | | |
| Storage stability of the | AA | A | B | B | AA | A |
| ink used | | | | | | |

| | Example 14 | Example 15 | Example 16 | Example 17 | Example 18 | Example 19 | Example 20 |
|---|---|---|---|---|---|---|---|
| Ink | Ink X | Ink A | Ink A | Ink Q | Ink R | Ink S | Ink T |
| Treatment liquid | Treatment | Treatment | Treatment | Treatment | Treatment | Treatment | Treatment |
| | liquid A | liquid B | liquid C | liquid A | liquid A | liquid A | liquid A |
| Treatment liquid loading | 10% | 10% | 10% | 10% | 10% | 10% | 10% |
| (% by mass, of ink) | | | | | | | |
| Attachment temperature | 35 | 35 | 35 | 35 | 35 | 35 | 35 |
| (° C.) | | | | | | | |
| Image quality (banding | AA | A | B | A | A | A | A |
| irregularities) | | | | | | | |
| Image quality (nonuniform | A | A | A | A | A | A | A |
| flocculation) | | | | | | | |
| Abrasion resistance | A | B | A | A | A | B | B |
| Recovery from clogging | B | A | A | A | B | B | B |
| [ink] | | | | | | | |
| Misalignment [treatment | A | A | A | A | A | A | A |
| liquid] | | | | | | | |
| Storage stability of the | B | AA | AA | AA | A | A | A |
| ink used | | | | | | | |

| | Example 21 | Example 22 | Example 23 | Example 24 | Example 25 | Example 26 |
|---|---|---|---|---|---|---|
| Ink | Ink A | Ink U | Ink V | Ink W | Ink A | Ink A |
| Treatment liquid | Treatment | Treatment | Treatment | Treatment | Treatment | Treatment |
| | liquid D | liquid A | liquid A | liquid A | liquid E | liquid F |
| Treatment liquid loading | 10% | 10% | 10% | 10% | 10% | 10% |
| (% by mass, of ink) | | | | | | |
| Attachment temperature | 35 | 35 | 35 | 35 | 35 | 35 |
| (° C.) | | | | | | |
| Image quality (banding | A | AA | B | B | AA | A |
| irregularities) | | | | | | |
| Image quality (nonuniform | A | A | A | A | B | B |
| flocculation) | | | | | | |
| Abrasion resistance | A | B | AA | AA | B | A |
| Recovery from clogging | A | B | A | B | A | A |
| [ink] | | | | | | |
| Misalignment [treatment | A | A | A | A | A | B |
| liquid] | | | | | | |
| Storage stability of the | AA | AA | AA | A | AA | AA |
| ink used | | | | | | |

| | | | | | | | Comparative |
|---|---|---|---|---|---|---|---|
| | Example 27 | Example 28 | Example 29 | Example 30 | Example 31 | Example 32 | Example 1 |
| Ink | Ink A | Ink A | Ink A | Ink A | Ink A | Ink A | Ink D |
| Treatment liquid | Treatment | Treatment | Treatment | Treatment | Treatment | Treatment | Treatment |
| | liquid G | liquid H | liquid A | liquid A | liquid A | liquid A | liquid A |
| Treatment liquid loading | 10% | 10% | 20% | 6% | 10% | 10% | 10% |
| (% by mass, of ink) | | | | | | | |
| Attachment temperature | 35 | 35 | 35 | 35 | 30 | 40 | 35 |
| (° C.) | | | | | | | |
| Image quality (banding | A | B | B | AA | AA | B | C |
| irregularities) | | | | | | | |
| Image quality (nonuniform | B | AA | AA | B | B | AA | A |
| flocculation) | | | | | | | |
| Abrasion resistance | B | B | B | AA | A | A | A |
| Recovery from clogging | A | A | A | A | AA | B | A |
| [ink] | | | | | | | |
| Misalignment [treatment | A | B | A | A | A | B | A |
| liquid] | | | | | | | |
| Storage stability of the | AA | AA | AA | AA | AA | AA | AA |
| ink used | | | | | | | |

| | Comparative | Comparative | Comparative | Comparative | Comparative |
|---|---|---|---|---|---|
| | Example 2 | Example 3 | Example 4 | Example 5 | Example 6 |
| Ink | Ink E | Ink N | Ink Y | Ink A | Ink D |
| Treatment liquid | Treatment | Treatment | Treatment | — | — |
| | liquid A | liquid A | liquid A | | |
| Treatment liquid loading | 10% | 10% | 10% | 0% | 0% |
| (% by mass, of ink) | | | | | |
| Attachment temperature | 35 | 35 | 35 | 35 | 35 |
| (° C.) | | | | | |
| Image quality (banding | AA | AA | AA | AA | A |
| irregularities) | | | | | |
| Image quality (nonuniform | A | A | A | C | C |
| flocculation) | | | | | |
| Abrasion resistance | B | C | D | AA | AA |
| Recovery from clogging | C | C | A | A | A |
| [ink] | | | | | |
| Misalignment [treatment | A | A | A | — | — |
| liquid] | | | | | |
| Storage stability of the | C | C | AA | AA | AA |
| ink used | | | | | |

### 3.3. Test Methods

### 3.3.1. Storage Stability (Ink Composition)

Thirty-gram samples of each ink jet ink composition obtained were sealed in an aluminum pack without allowing air into it and aged at 60° C. for 6 days using a temperature-controlled chamber. The aged samples were removed and allowed to cool, their viscosity at a shear rate of 200 s⁻¹ was measured at room temperature using a rheometer (trade name “MCR702,” Anton Paar), and the percentage increase in viscosity was calculated by comparing it with the initial viscosity (that of the freshly prepared ink).

### Grading Criteria

AA: The percentage increase in viscosity is less than 1%

A: The percentage increase in viscosity is 1% or more and less than 3%

B: The percentage increase in viscosity is 3% or more and less than 5%

C: The percentage increase in viscosity is 5% or more

### 3.3.2. Image Quality (Banding Irregularities)

The ink sets of each example or comparative example, including a resulting ink jet ink composition and treatment liquid, were loaded into a modified version of Seiko Epson Corporation's “SC-R5050” printer, a recording medium (PVC film, trade name “Orajet 3165G-010,” ORAFOL Japan Inc.) was set in place, and a solid pattern was printed with the print parameters presented in Table 4 above.

More specifically, the ink jet ink composition (ink) and treatment liquid for each example or comparative example, specified in Table 4 above, were loaded into ink cartridges of “SC-R5050.” By ink jet technology, the ink and the treatment liquid were ejected from the ink jet head onto the recording medium to print a solid pattern with a resolution of 1200×1200 dpi in nine scans. The ink loading was 12 mg/inch², and the treatment liquid loading was as specified in Table 4. During recording, a platen heater was controlled to make the surface temperature of the recording medium at the platen's region facing the head equal to the heating temperature (attachment temperature) given in Table 4.

Lastly, the recording medium was dried by heating for about 3 minutes by heating it to a surface temperature of 90° C. with a second heater, located downstream of the ink jet head, finishing a printed article. The resulting printed article was visually inspected and graded according to the following criteria.

### Grading Criteria

AA: No visible density irregularity in the main scanning direction (streak-like variation in density in the main scanning direction)

A: There are some pale, streak-like irregularities, but the difference in density is small and inconspicuous

B: There are streak-like density irregularities. The difference in density is large but acceptable

C: There are streak-like density irregularities. The difference in density is large and conspicuous

### 3.3.3. Image Quality (Nonuniform Flocculation)

A printed article was obtained in the same way as in the “Image Quality (banding irregularities)” evaluation study, except that the ink loading was 16 mg/inch². The resulting printed article was visually inspected and graded according to the following criteria.

### Grading Criteria

AA: Flocculation is uniform

A: Flocculation is nonuniform but not to a noticeable extent

B: Flocculation nonuniformity is conspicuous but acceptable

C: Flocculation nonuniformity is conspicuous

### 3.3.4. Abrasion Resistance

A printed article was obtained in the same way as in the “Image Quality (banding irregularities)” evaluation study, except that the ink loading was 16 mg/inch². The resulting printed article was then left at room temperature for 30 minutes, an area with the printed solid pattern was cut into a 30×150-mm rectangle thereafter, and the cut specimen was rubbed 100 times with a piece of plain-woven fabric using a color fastness rubbing tester (load, 500 g). The rubbed specimen was visually inspected for ink peeling, and the degree of ink peeling was graded according to the following criteria.

### Grading Criteria

AA: No peeling

A: The ink peeled in less than 20% of the test area B: The ink peeled in 20% or more and less than 40% of the test area

C: The ink peeled in 40% or more and less than 60% of the test area

D: The ink peeled in 60% or more of the test area.

3.3.5. Recovery from Clogging (Ink Composition)

The print parameters were the same as in the “Image Quality (banding irregularities)” evaluation study. The recording this time, however, was a simulation, in which the head ran idle, without ejecting the ink, after its ink nozzles were disabled for ejection. The treatment liquid was not ejected either. The simulation recording was conducted for 3 hours. Then the head was cleaned three times, and the ink was graded according to the criteria below for how many ink nozzles failed to eject the ink after the cleaning. Each time of cleaning drained 1 g of the ink from the row of nozzles. The nozzles were disabled done by patting the nozzle side of the head with a water-dampened Bemcot wiper. The row of nozzles had 400 nozzles.

### Grading Criteria

AA: No nozzle fails to eject the ink

A: Less than 3% of the nozzles fail to eject the ink

B: 3% or more and less than 5% of the nozzles fail to eject the ink

C: 5% or more of the nozzles fail to eject the ink

### 3.3.6. Foam Breaking (Ink Composition)

Twenty grams of the ink jet ink composition obtained as described above was put into a 110-mL screw vial, which was then shaken up and down ten times over a distance of 30 cm. Based on the height of produced foam was monitored over time, the ink was graded according to the following criteria.

### Grading Criteria

AA: The time for the foam to shrink to 2 mm or lower is less than 15 minutes

A: The time for the foam to shrink to 2 mm or lower is 15 minutes or more and less than 30 minutes

B: The time for the foam to shrink to 2 mm or lower is 30 minutes or more and less than 1 hour

C: The time for the foam to shrink to 2 mm or lower is 1 hour or more

### 3.3.7. Misalignment (Treatment Liquid)

The system configuration was the same as in the “Image Quality (banding irregularities)” evaluation study. The head was flushed with the treatment liquid therein, and a nozzle check pattern was recorded immediately. Then the head was run idle for 1 minute, ejecting no ink jet ink composition and no treatment liquid. After the idle run, the same nozzle check pattern was recorded with the treatment liquid, and the treatment liquid was graded according to the criteria below. The average misalignment across all nozzles was reported as the distance of misalignment, excluding nozzles that failed to eject the treatment liquid.

### Grading Criteria

A: No difference between the landing points before and after the idle run

B: The distance of misalignment is equal to or smaller than the nozzle pitch

C: The distance of misalignment is larger than the nozzle pitch

### 3.4. Test Results

The test results are presented in Table 4 above.

As shown by the test results, all Examples were superior in image quality (reduction of nonuniform flocculation) and achieved good reduction of banding irregularities, good storage stability of the ink jet ink composition, and abrasion resistance.

The Comparative Examples, by contrast, were all inferior in at least one of image quality, the reduction of banding irregularities, storage stability, or abrasion resistance.

Comparative Example 1, in which the ink contained no organic compound sparingly soluble in water, was inferior in reducing banding irregularities.

Comparative Example 2, in which the concentration of the organic compound sparingly soluble in water in the ink was out of range, was inferior in the storage stability of the ink.

Comparative Examples 3 and 4, in which the organic compound sparingly soluble in water in the ink was not a right one, was inferior in the storage stability of the ink or abrasion resistance.

Comparative Examples 5 and 6, in which no treatment liquid was used, was inferior in image quality (nonuniform flocculation).

Although omitted in the tables, an alternative of ink A was prepared without the water-soluble organic compounds of PG, 1,2HD, and TIPA, and an ink set including it was tested in the same way as in Example 1. The ink set was inferior in at least recovery from clogging.

From the embodiments described above, the following can be derived.

A form of an ink set is: an ink set including a flocculant-containing treatment liquid; and an ink jet ink composition, the ink set being for use in recording on a low- or non-absorbent recording medium, wherein: the ink jet ink composition is a water-based ink containing at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C.; and the organic compound sparingly soluble in water includes a diol or glycol ether having a normal boiling point of 180° C. to 300° C., with the diol or glycol ether constituting 2.3% by mass or less of the total mass of the ink composition.

In the above form of an ink set, the diol or glycol ether having a normal boiling point of 180° C. to 300° C. may be a 1,3-alkanediol represented by general formula (1), alicyclic diol, or glycol ether having six or more carbon atoms:

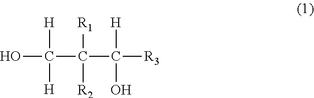

(where each of R₁, R₂, and R₃ is independently hydrogen or an alkyl group, and the total number of carbon atoms in R₁, R₂, and R₃ is from 3 to 9).

In any of the above forms of an ink set, the ink jet ink composition may contain, as a water-soluble organic compound as defined above, a resin-dissolving substance that is an amide, sulfur-containing solvent, or cyclic ether having a normal boiling point of 150° C. to 300° C., with the substance constituting 20% by mass or less of the total mass of the ink composition.

In any of the above forms of an ink set, the ink jet ink composition may contain, as a water-soluble organic compound as defined above, a polyol or glycol ether having a normal boiling point of 150° C. to 250° C., with the polyol or glycol ether constituting 30% by mass or less of the total mass of the ink composition.

In any of the above forms of an ink set, the ink jet ink composition may contain, as a water-soluble organic compound as defined above, an alkanediol having six or fewer carbon atoms and having a normal boiling point of 150° C. to 250° C., with the alkanediol constituting 10% to 25% by mass of the total mass of the ink composition.

In any of the above forms of an ink set, the treatment liquid may contain a diol or glycol ether that is an organic compound sparingly soluble in water as defined above and has a normal boiling point of 180° C. to 300° C.

In any of the above forms of an ink set, the ink jet ink composition may contain a silicone surfactant at a concentration of 0.1% to 1.5% by mass of the total mass of the ink composition.

A form of a recording method is: a recording method in which recording is performed using an ink set in any of the above forms, the method including: an ink attachment step, in which the ink jet ink composition is ejected by ink jet technology and attached to a recording medium; and a treatment liquid attachment step, in which the treatment liquid is attached to the recording medium, wherein: the recording medium is a low- or non-absorbent recording medium.

In the above form of a recording method, the recording involves multiple main scans, and multiple main scans are made in the same scan area.

Any of the above forms of a recording method may further include: a first heating step, in which the ink jet ink composition attached to the recording medium is heated.

Any of the above forms of a recording method may further include: a postheating step, in which the recording medium is heated, after the ink attachment and treatment liquid attachment steps.

The present disclosure is not limited to the above embodiments, and many variations are possible. For example, the present disclosure embraces configurations substantially identical to those described in the embodiments, such as configurations identical in function, methodology, and results to or having the same goal and offering the same advantages as the described ones. The present disclosure also includes configurations created by changing any nonessential part of those described in the above embodiments. Furthermore, the present disclosure encompasses configurations identical in operation and effect to or capable of fulfilling the same purposes as those described in the above embodiments. Configurations obtained by adding any known technology to those described in the embodiments are also part of the present disclosure.

What is claimed is:

1. An ink set comprising:
a flocculant-containing treatment liquid; and an ink jet ink composition,
the ink set being for use in recording on a low- or non-absorbent recording medium, wherein:
the ink jet ink composition is a water-based ink containing at least one colorant, at least one water-soluble organic compound, having a solubility of more than 10 g in 100 g of water at 20° C., and at least one organic compound sparingly soluble in water, having a solubility of 0.1 to 10 g in 100 g of water at 20° C.; and
the organic compound sparingly soluble in water includes a diol or glycol ether having a normal boiling point of 180° C. to 300° C., with the diol or glycol ether constituting 2.3% by mass or less of a total mass of the ink composition.

2. The ink set according to claim 1, wherein:
the diol or glycol ether having a normal boiling point of 180° C. to 300° C. is a 1,3-alkanediol represented by general formula (1), alicyclic diol, or glycol ether having six or more carbon atoms: 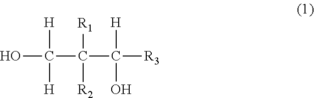
where each of R₁, R₂, and R₃ is independently hydrogen or an alkyl group, and a total number of carbon atoms in R₁, R₂, and R₃ is from 3 to 9.

3. The ink set according to claim 1, wherein:
the ink jet ink composition contains, as a water-soluble organic compound as defined above, a resin-dissolving substance that is an amide, sulfur-containing solvent, or cyclic ether having a normal boiling point of 150° C. to 300° C., with the substance constituting 20% by mass or less of the total mass of the ink composition.

4. The ink set according to claim 1, wherein:
the ink jet ink composition contains, as a water-soluble organic compound as defined above, a polyol or glycol ether having a normal boiling point of 150° C. to 250° C., with the polyol or glycol ether constituting 30% by mass or less of the total mass of the ink composition.

5. The ink set according to claim 1, wherein:
the ink jet ink composition contains, as a water-soluble organic compound as defined above, an alkanediol having six or fewer carbon atoms and having a normal boiling point of 150° C. to 250° C., with the alkanediol constituting 10% to 25% by mass of the total mass of the ink composition.

6. The ink set according to claim 1, wherein:
the treatment liquid contains a diol or glycol ether that is an organic compound sparingly soluble in water as defined above and has a normal boiling point of 180° C. to 300° C.

7. The ink set according to claim 1, wherein:
the ink jet ink composition contains a silicone surfactant at a concentration of 0.1% to 1.5% by mass of the total mass of the ink composition.

8. A recording method in which recording is performed using the ink set according to claim 1, the method comprising:
an ink attachment step, in which the ink jet ink composition is ejected by ink jet technology and attached to a recording medium; and a treatment liquid attachment step, in which the treatment liquid is attached to the recording medium, wherein:
the recording medium is a low- or non-absorbent recording medium.

9. The recording method according to claim 8, wherein:
the recording involves a plurality of main scans, and a plurality of main scans are made in the same scan area.

10. The recording method according to claim 8, further comprising:
a first heating step, in which the ink jet ink composition attached to the recording medium is heated.

11. The recording method according to claim 8, further comprising:
a postheating step, in which the recording medium is heated, after the ink attachment and treatment liquid attachment steps.
